(19) United States
(12) Patent Application Publication
(10) Pub. No.: US 2026/0220332 A1
(43) Pub. Date: Jul. 30, 2026

(54) FRACTAL-BASED SYSTEMS AND METHODS FOR OPTIMIZING MATTER, ENERGY, AND DATA MANIPULATION

(71) Applicant: Gregory Marcus Friedlander, Mobile, AL (US)

(72) Inventor: Gregory Marcus Friedlander, Mobile, AL (US)

(21) Appl. No.: 19/037,251

(22) Filed: Jan. 26, 2025

(51) Int. Cl. G06F 30/27; G06F 111/10

(52) U.S. Cl. CPC G06F 30/27; G06F 2111/10

(57) ABSTRACT

The present invention relates to a method for improving processes in various undertakings by employing Key Fractal Elements (KFE). The method involves utilizing KFE to affect change in CT states and interpret matrices of CT states. By applying KFE elements, categorization, prediction, manipulation, and the design of radiation matrices for electronics, solar, thermal, fusion, and radioactive energy applications are achieved. By incorporating KFE, improved balance, plasma fulcrums, and efficient CT state interactions are achieved, leading to advancements in various fields. The application of KFE in reaction processes, fuel utilization, electronics, and energy management contribute to superior matrix changes and efficient pretime informational exchange.

### BACKGROUND

### Technical Field

The present disclosure relates to the field of integrated quantum fractal modeling, and in particular, relates to fractal-based systems and methods for optimizing matter, energy, and data manipulation.

### Description of the Related Art

In the current scientific landscape, inconsistent data terminology, varied languages, and fragmented data structures prevail across disciplines such as physics, chemistry, biology, and engineering. These inconsistencies hinder the effective use, extraction, and analysis of knowledge, creating challenges for artificial intelligence (AI) systems to process scientific data efficiently.

Existing approaches in the prior art have sought to address these issues by developing intuitive models for data analysis. However, these models typically rely on heuristic or empirical methodologies rather than on robust mathematical frameworks. Although some advancements have been made, these solutions are insufficient in providing a comprehensive and unified method for managing the diverse and complex nature of scientific data across multiple fields. The limitations of these current approaches are numerous. Intuitive models often lack the precision and reliability inherent in math-based models, leading to limited utility, and inaccuracies in data interpretation and analysis.

The fragmented nature of data structures and terminologies across various disciplines complicates the integration and synthesis of scientific knowledge. These issues significantly impede scientific research progress and the development of innovative solutions.

### BRIEF SUMMARY

One or more embodiments are directed to fractal-based systems and methods (hereinafter may also be termed as “mechanism”) for optimizing matter, energy, and data manipulation. The disclosed mechanism encompasses various embodiments that utilize Key Fractal Elements (KFE) for manipulating matter and energy through advanced fractal modeling. The disclosed mechanism is configured to apply fractal mathematics to optimize scientific data analysis across multiple disciplines, including physics, chemistry, biology, and engineering.

In an embodiment, the disclosed mechanism employs fpix equations and MI-based Fibonacci sequences to model and predict the behavior of complex systems. Such equations and sequences define transitions between different states, and transitions reflected in golden ratio curves and MI areas from fpix geometry (FIG. 15) to reflect the interconnected nature of fractal structures. The disclosed mechanism utilizes reciprocals of KFE, resonance patterns, and compression equations such as 2 f(x)\hat{ }2x derived from resonance relationships to describe exponential change and the grouping of information states as compression (growth) and decompression (deterioration) in the modeled systems.

In an embodiment, the disclosed mechanism focuses on the application of fractal modeling in energy conversion and management. Further, the disclosed mechanism includes designing semiconductors that convert radiation into electricity using fractal patterns. Materials such as lead (Pb), tin (Sn), and their hybrids are optimized for energy transfer based on fractal modeling. The disclosed mechanism enhances nuclear fusion and fission processes through the design of radiation matrices and fission chips that incorporate fractal-layered structures matching reaction transitions including those reflecting compression and decompression as different forms of energy. The disclosed mechanism also extends to Artificial Intelligence (AI) systems where fractal modeling is integrated into the AI to convert empirical data into fractal-based representations. Such an integration allows AI systems to predict chemical and biological functions. AI software based on these fractal methods generates fractal models that predict transitions between different iterations of dimension, including fractal iterations defining energy and matter, refining these models based on real-time feedback and discrepancies with empirical data.

In an embodiment, the disclosed mechanism applies fractal modeling to optimize chemical and biological processes. Fractal overlaps of molecular states are used to predict more selective and efficient chemical reaction pathways. In biological systems, fractal patterns are used to predict behaviors and optimize biological processes based on transitions captured through fractal modeling. In an embodiment, the disclosed mechanism addresses quantum and computational systems by involving the analysis and manipulation of information states using fractal-based dimensional features. Such an approach improves the stability of quantum states and enhances computational efficiencies in quantum computing by leveraging fractal-defined transitions. The disclosed mechanism uses the versatility and applicability of Key Fractal Elements (KFE) in various scientific and technological domains. By providing a rigorous, fractal-based framework, the disclosed mechanism enables precise modeling and manipulation of complex systems, leading to advancements in scientific research and technological innovation.

An embodiment of the present disclosure discloses a method for manipulating dimensional transitions such as those leading to matter and energy using Key Fractal Elements (KFE). The method includes the steps of identifying a target system with dimensional features defined by fractal-based models. The dimensional features including solutions to fpix equations for curvature-based compression states, MI-based Fibonacci sequences for dimensional transitions, transitions between the fpix and MI, wherein the transitions occur in either direction, reflecting the gradual change from the fpix to MI, and vice versa, further wherein a golden ratio is a combination of both the fpix and MI elements, showing the interconnected nature in creating fractal structures, resonances such as by the intersections of a plot of fpix to plots of n/fpix, reciprocals of one or more elements from the fpix and MI, resonance resulting from the interaction of the one or more elements, and/or compression equation (2f(x)\hat{ }2(x)) describing exponential growth and compression, wherein f(x) corresponds to the fpix and/or the MI depending on the state being modeled. Further, the method includes the steps of applying fractal modelling to determine optimal transitions between compression and decompression states within the target system. Furthermore, the method includes the steps of adjusting input parameters to the target system based on predicted fractal patterns related to the KFE. The method includes the steps of monitoring real-time changes in the target system using fractal constraints. Thereafter, the method includes the steps of iteratively refining the process to optimize the desired physical, chemical, and energetic outcome. Fpix is a term used to represent one or more of a series of solutions to the equation fpix.

In an embodiment, the fractal modelling incorporates a resonance based on 2n or 4n iterations, compression states based on 2n; 2f(n) where f(n) corresponds to fpix, CGP, MI, and/or a transition state, dimensional transitions, and/or a transition equation including at least one KFE involving 2f(n)\hat{ }(2\hat{ }n), where f(n) is selected from fpix, MI, and/or a transition state between fpix and the MI. In an embodiment, the method includes the steps of designing matrices for space, energy, atomic and molecular structures based on KFE by identifying and categorizing dimensional features using fractal patterns, and/or modelling compression and/or decompression states to optimize molecular and atomic interactions. In an embodiment, the target system is a radioactive material, and the method includes the steps of using the fractal modelling to design semiconductors for converting radiation into electricity and/or incorporating fractal structures to target at least one fractal transition giving rise to at least one potential (as the term is used in power generation) which ca be converted into usable energy such as an electron or proton movement. In one embodiment this uses materials including at least one of: lead (Pb), tin (Sn), and corresponding hybrids with semiconductors to control the transitions to shield radiation or increase or localize energy potentials and energy transfer.

In an embodiment, the method includes the steps of optimizing nuclear fusion processes by designing radiation matrices for fusion energy production and/or using KFE to build concentrations of ct states or otherwise structure fusion reactions and enhance energy release. In an embodiment, the method includes the steps of optimizing nuclear fission processes by designing fission chips with fractal-layered structures for energy conversion and/or controlling fission reactions using KFE to maximize energy output and design a safer mechanism. In an embodiment, the fission chip includes layers incorporating fractal models for efficient energy generation and energy transfer and/or systems for converting radiation into usable energy through fractal-guided dimensional changes of fractal matrices. In an embodiment, the fractal modelling is integrated into artificial intelligence software to convert empirical scientific data into fractal-based representations, predict chemical and biological functions using fractal algorithms, and/or enhance the accuracy and efficiency of AI systems in analyzing scientific data. In an embodiment, the method includes using the AI software to generate fractal models predicting transitions between energy and matter and/or refine fractal predictions based on discrepancies with empirical data. In an embodiment, the AI system is further configured to generate automated fractal classifications for unstructured scientific data and/or identify non-fractal anomalies within datasets to improve prediction accuracy and efficient information processing by providing common terminology across disciplines using fractal nomenclature based on KFE.

In an embodiment, the method includes the steps of using the fractal modelling to optimize chemical reactions by predicting reaction kinetics using fractal overlaps of molecular states and/or designing reaction pathways to enhance selectivity and product yield. Further, the fractal modelling is applied to biological systems to predict biological behaviors using fractal patterns and/or optimize the design of biological processes based on fractal transitions. Furthermore, the fractal modelling is used to design radiation matrices for energy storage systems and the method includes the steps of configuring layers to optimize pretime energy capture and release using fractal principles and/or incorporating fractal resonance to control or stabilize energy generation, transitions, storage, and transfer. In an embodiment, the method includes the steps of designing layered semiconductor arrays for processing including fission and fusion systems, wherein the arrays leverage overlapping MI spirals for neutron compression and/or optimize energy transfer and reduce waste heat using fractal transitions which may include treating time as an effect of dimensional transitions based on KFE defined fractals.

An embodiment of the present disclosure discloses a system for automated fractal analysis of empirical data. The system includes a database for storing empirical data related to atomic, electromagnetic, chemical, or biological systems. One embodiment includes a software module configured to extract features from the data and categorize them using fractal constraints, generate fractal models predicting transitions between energy and matter, and/or perform simulations to validate the fractal models against empirical data. In an embodiment, the system further includes a processor configured to iteratively refine the fractal models based on discrepancies between simulation results and empirical data.

An embodiment of the present disclosure discloses a method for analyzing dimensional features using fractal-based modelling. The method includes the steps of identifying dimensional features within a target system based on solutions to fpix equations and categorizing the features into compression and decompression states using fractal overlaps. Further, the method includes the steps of designing transitions between features to optimize the behavior of the target system. Also, the method includes the steps of using KFE, including fractal resonance to improve system efficiencies in applications selected from AI, electromagnetic, electromechanical systems, chemical reactions, energy storage or generation, and/or quantum computing.

In an embodiment, the method includes the steps of using fractal modelling to enhance energy conversion by configuring transitions between fpix-defined geometries and MI-defined geometries at neutron bonding, and/or optimizing electromagnetic interactions for improved energy transfer. In an embodiment, the method includes the steps of using fractal modelling to design molecules with tailored properties for energy systems. In an embodiment, the method includes the application is quantum computing. The fractal modelling is used to optimize the stability of quantum states and/or enhance computational efficiencies using fractal-defined transitions.

The present invention offers several notable advantages by achieving a unified approach to modeling, designing, and understanding various systems and processes through a single underlying mathematical framework. By substituting different technologies and languages with fpix solutions (ct1 states), the invention streamlines and enhances the efficiency of scientific modeling. This innovation allows for translating any desired outcome into the FIP model, enabling the most efficient execution of processes. It provides a method for converting prior art modeling into FIP modeling, fostering a deeper and more efficient understanding of features from a novel perspective. The invention also significantly enhances the application of fractals in data science, modifying AI software to maximize the accessibility, organization, and value of empirical data. This approach allows for the use of fractal modeling to design chemical and biological functions, improving the accuracy and efficiency of AI predictions. The fractal model is versatile, and applicable across various systems such as energy, atomic, chemical, and biological systems, and it enables the categorization of data from sub-atomic to astronomical features within a unified framework.

One embodiment develops a classification system that cross-characterizes existing empirical non-fractal data across multiple scientific domains, aligning them with the fractal modeling framework. Integrating this fractal model into AI software enhances the software's capability to access, organize, and analyze empirical data more effectively, thereby improving the prediction of chemical and biological functions. In the context of atomic interactions and energy transfer, the invention utilizes fractal analysis to identify patterns in empirical data, developing fractal atomic structure definitions and mathematical models that optimize transitions between energy and matter. This leads to increased efficiency in energy processes. The system for automated fractal analysis of empirical chemistry data is another advantage, comprising a database, software module, and processor that facilitate the extraction, categorization, and simulation of data based on fractal constraints. This system optimizes reactions and energy processes by utilizing Key Fractal Elements (KFE) to design transitions to influence CT states and interpret matrices of these states. Moreover, the invention provides a method for controlling the compression and decompression of CT states within and between multiple AuT matrices, governing changes through KFE to achieve desired dimensional variations. This control extends to the creation of new materials and substances and enables the modeling and simulation of complex systems and phenomena, offering a powerful method for predicting the behavior of dimensional systems.

The Features and advantages of the subject matter here will become more apparent in light of the following detailed description of selected embodiments, as illustrated in the accompanying FIGUREs. As will be realized, the subject matter disclosed is capable of modifications in various respects, all without departing from the scope of the subject matter. Accordingly, the drawings and the description are to be regarded as illustrative in nature.

### BRIEF DESCRIPTION OF THE DRAWINGS

In the figures, similar components and/or features may have the same reference label. Further, various components of the same type may be distinguished by following the reference label with a second label that distinguishes among the similar components. If only the first reference label is used in the specification, the description is applicable to any one of the similar components having the same first reference label irrespective of the second reference label.

FIGS. 1 and 1A illustrate representative features for Fission Modeling, in accordance with various embodiments of the present disclosure.

FIGS. 1B and 1C show an alternate arrangement of the fission generation and transition elements set out in FIG. 1.

FIG. 2 illustrates a representative view of ct3 to ct4 compression, in accordance with various embodiments of the present disclosure.

FIG. 2A illustrates how energy is represented by pretime change of particles, in accordance with various embodiments of the present disclosure.

FIG. 2B illustrates 3 of the 7 relative compression sizes in base 14 (2*7), in accordance with various embodiments of the present disclosure.

FIG. 2C illustrates electron structure in base 14, in accordance with various embodiments of the present disclosure.

FIG. 2D illustrates a view of plasma modeling, in accordance with various embodiments of the present disclosure.

FIG. 3 illustrates a representative view of magnetism from electricity based on fractal modeling and associated magnetic attraction, in accordance with an embodiment of the present disclosure.

FIG. 4 illustrates a representative view of magnetic repulsion based on fractal modeling, in accordance with an embodiment of the present disclosure.

FIG. 5 illustrates a representative view of the growing proton count for protons based on fractal modeling, in accordance with an embodiment of the present disclosure.

FIG. 6 illustrates a representative view of carbon based on fractal modeling, in accordance with various embodiments of the present disclosure.

FIG. 7 illustrates a representative view of how carbon can be categorized using fractal terminology for AI/ML applications.

FIG. 8 illustrates a representative view of neutron bonding seen in larger atoms as sets of carbon-like base structures, in accordance with various embodiments of the present disclosure.

FIG. 9 illustrates the carbon and argon neutron features from FIGS. 6, 7, and * give rise to the structures, in accordance with various embodiments of the present disclosure.

FIG. 10 illustrates an example of the fpix to MI transition, in accordance with various embodiments of the present disclosure as a way to view the MI series as coming off in another dimension from fpix compression modeling.

FIG. 11 illustrates bonding represented from fractal modeling of atoms, in accordance with an embodiment of the present disclosure.

FIG. 12 illustrates a representative view of hydrogen separation using fractal modeling, in accordance with an embodiment of the present disclosure.

FIG. 13 illustrates a representative view of water using fractal modeling, in accordance with an embodiment of the present disclosure.

FIGS. 14 and 14A illustrate fusion modeling using fractal modeling, in accordance with various embodiments of the present disclosure.

FIG. 14B shows an alternate arrangement for the embodiment of FIG. 14.

FIG. 15 illustrates a method of using the taught geometries to get neutron compression.

FIG. 16 illustrates the composite modeling of an Eddington-type Atom with Fpix and MI overlapping spiral modeling together, in accordance with various embodiments of the present disclosure.

FIG. 17 illustrates a representative view of one form of ct1 solution folding, in accordance with various embodiments of the present disclosure.

FIG. 18 illustrates the process steps to carry out fractal modeling of existing science and to use that in further design, in accordance with various embodiments of the present disclosure.

FIGS. 19 and 19A illustrate different fractal transitions within resonance, in accordance with an embodiment of the present disclosure.

FIG. 20 illustrates modeling of resonance in a chart, in accordance with an embodiment of the present disclosure showing the transition between fpix and MI using nonreal and real numbers.

Other features of embodiments of the present disclosure will be apparent from accompanying drawings and detailed description that follows.

### DETAILED DESCRIPTION

Key fractal elements are discussed. Resonance based fulcrums represented by 2fn\hat{ }2n; are taught in this specification.

Features of Key Fractal Elements (KFE) can be used for modeling or manipulation.

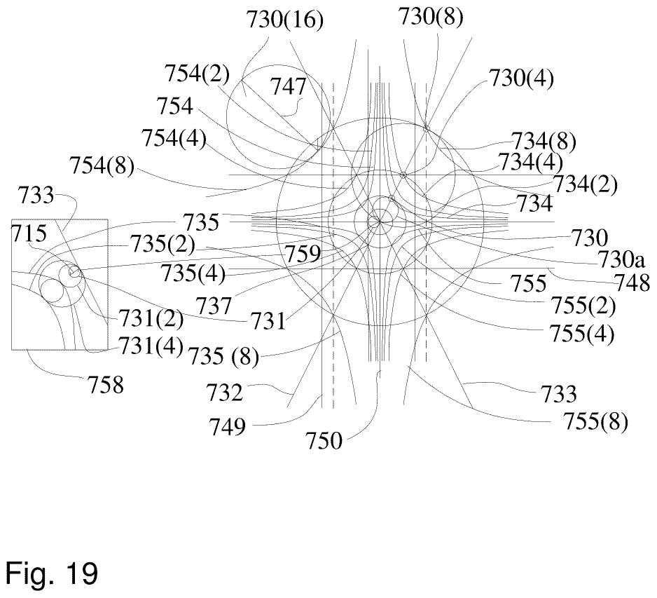

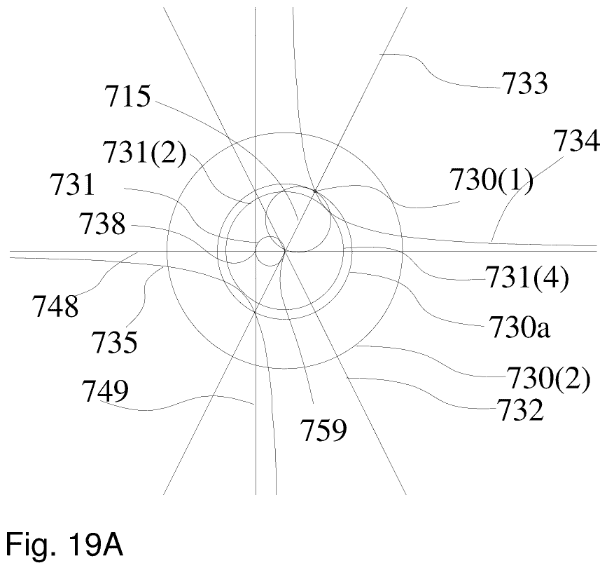

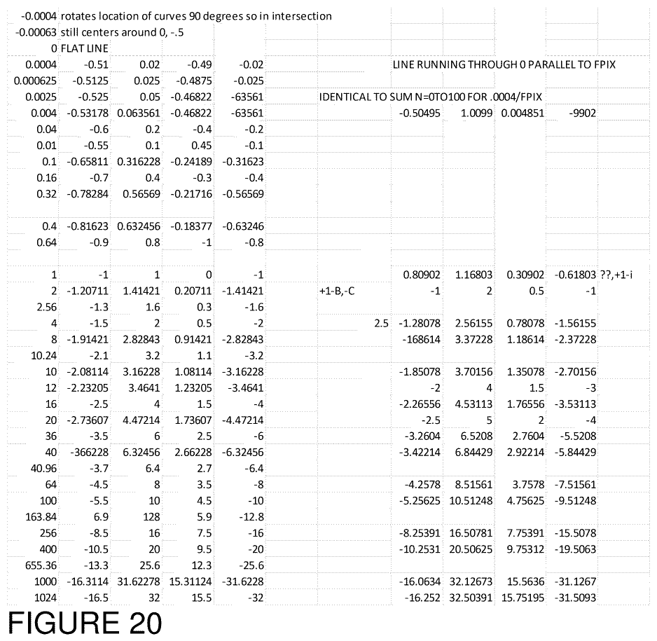

Fractal Iterated Equations include:
a. Fpix (the reciprocal defining curvature and the relationship between fpix and the reciprocal defining resonance)
b. MI (neutron level compression) evolving from fpix
c. Resonance as defined for fpix, where 2f(x)\hat{ }2(x) is an example which can be used to separate ct1 from ct2 by changing x from 1 to 2 by way of example.
d. Compression and decompression along fractal lines leads to quantum Stepped Fractal Dimensional States defined by iterated equations of fractal compression or decompression.
e. Fuse Length: Quantum counts between changes in ct1 states.
f. Inflection points as the tendencies towards or away from compression.
g. Interim transitions and transitional states between et states based on ct1 and the transition from fpix to MI architecture.
h. Shifting center points of origin for resonance, 0.5 offsets (see the discussion of item 731) as well as the original center point defined by overlap of MI spirals (item 67e), the intersection of axis discussed in FIG. 19 among those taught herein as well as the exponential expansion of those and the diameters of resonance shown by the space (as of between items 734 and 735 about the axis defined by items 732 and 733
i. Various stable and unstable associations and separations inherent in the resulting solutions, particularly those resulting from resonance or associated fulcrums.

Base FIP Transitions Governing matrix composition and interaction include Balance and Fulcrums: Charting resonance as transitional steps in compression, Dimensional Building as a Function of changing et states and resonance, KFE Fulcrums based on resonance associate ct1 solutions building dimensional features which allows Targeting Fulcrums which involves targeting the fulcrum building process, structure and the information present in fulcrums and the resulting stepped transitions which are viewed as forces.

One effect of dimension building is offset spirals seen as fpix curves at the fpix level and MI based spirals starting with neutron bonding. Graphing of n/fpix shows inherent offset spirals, which are mirrored and lead to golden ratio spirals of galaxies and overlapping MI spirals of neutron structural calculations.

Modeling of Virtual Fulcrums includes the type of fulcrum, fpix curves, MI spirals, intermediary transitions between those curves and spirals, offsets which include stepped energy transitions in atoms, potential associated with the separations, releases of information represented by collapse of fulcrums, balance of information into and out of the fulcrum, variable separation, and resonance.

Fulcrum Evolution: Base structure of fulcrum evolution results from resonance; balance and folding around fulcrums by absorption and spew between the matrix in which the fulcrum exists and the fulcrum and surrounding et states including neutrons, protons, electrons and photons as designations of et states from the prior art. Higher Compression States, ct2, and higher CT states form within shells of folding lower states within fulcrum based resonance structures.

Application of KFE involves Affecting change in CT states, categorizing matrices, and manipulating them and includes: energy conversion by using KFE to stage energy transitions in various devices and fuels, using fractal based dimensional Variations based on the building of dimensions by the compression and decompression about resonance based fulcrums, design of machines and reactions using KFE, reduction of Variables in processing by replacing other designations (physics [time, force, energy], chemistry [chemical structures and biological structures and the matrices defined by them], etc) with terms or designations based on KFE modeling.

This involves a Unified Data Structures: Substituting various technologies and languages with a single underlying mathematical parameter (fpix solutions built on other fpix solutions called ct1 states). The building process involves association of information around fulcrums built on resonances of fpix:1/fpix solutions and resulting evolutions of ct1 states into higher et states as well as transitions to different architectures, particularly MI based architecture at the neutron level.

This includes translating any desired dimensional manifestation or outcome into the FIP model, converting prior art modeling into FIP modeling.

One result is a new classification System cross-characterizing empirical non-fractal data with fractal modeling.

Integration with AI Software includes Integrating the fractal model into AI software to increase predictive capabilities which allows Modeling Atomic Interactions and modeling atomic interactions for energy transfer using fractal analysis,

Automated Fractal Analysis: System for automated fractal analysis of empirical chemistry data including optimization of reactions and energy processes using KFE to optimize reactions and energy processes, control of CT State Changes including controlling compression and decompression by designing and carrying out fulcrum changes based on CT states and example being working with Magnetic Repulsion Effects where Magnetic repulsion effects are pretime fulcrum compression and decompression working like high and lower pressure system interactions.

Grouping of KFE: Group 1: Fractal Elements of CT States which include the features of the math giving rise to ct1: Stepped AuT Fractal Transitions: Defined by fractal transitions governing CT state changes, including Fpix offset spirals and MI overlapping spirals; Pairing Higher Compression CT States: Along f-series linear spirals, curved spirals, and shared lower compression CT states; Compression and decompression along fractal linear spirals of CT states folding about at least one AuT fulcrum; Fulcrums as Shared Information: Fulcrums act as shared information by higher CT states along KFE rules of compression; Fractal Balance: Alignment of at least two higher compression CT states about at least one AuT fulcrum; Compression and Decompression: Defined as numerically increasing or lowering lower compression CT states between higher compression CT states along fulcrums CT States as Stepped Fractal Dimensional States: Defined by iterated equations of fractal compression or decompression from association around fulcrums; Force: Result of net compression or decompression of CT states; Time: Our view of a type of stop-frame animation from changes in pretime CT states, particularly at the level of photons; Redefining Relativistic Effects as the difference between pretime and time-based change based on the resulting classical math being applicable in place of relativistic math.

Grouping of KFE: Group 2: Elements Related to AuT Matrices includes: Base State Changes: Inherent in CT state folding; Defining Base Logic: Using KFE to define base logic to categorize AuT matrices; Offset Fractal Spirals: Balance and imbalance about fulcrums, dimensional variation, and energy exchange within fractal structures; force as Net Compression and Decompression: Within an AuT matrix and shifting between higher and lower compression; Absorption and Spew: Between at least two AuT matrices as collision effects; CT State Exchange: In place of collision or field modeling.

AuT Matrix Categorization is possible based on the KFE including CT State Content: Categorization based on CT state content; Number, Type, and Organization: Fractal organization of CT states; Base Numbering State: Relative dimensional size to at least one second matrix; Locational Area based on matrices and dimensions built; Perspective of time generated by pretime change; Fulcrum Locations: Locational categorization of fulcrums; Pretime and Post-Time Change: Amount of pretime change and resulting post-time perspective change of the CT states, and compression and decompression tendency within a matrix; Thermodynamic Effects: Based on categorized CT states within an AuT matrix; Absorption and Spew of CT States from fulcrums and matrices built from fulcrums; Fpix curves and F-series Spirals built from the Alignment of CT states.

This provides a broad base for dimensional manipulation. This includes a method for manipulating dimensions in a system comprising: (a) identifying a target dimension within the system; (b) determining a desired state for the target dimension; (c) identifying a set of KFE parameters associated with the target dimension, wherein said KFE parameters comprise at least one of the KFE which include: CT states and Fpix, MI (Indian Method/Fibonacci Sequence) as it evolves from fpix, Interim Transitions between Fpix and MI, v) Compression/Decompression about fulcrums, recognizing the nature of time and pretime change particularly allowing classical math in place of relativisitic math, Spiral Alignment and curved alignment about Fulcrums defined by resonance, Absorption/Spew as the exchange of information within fulcrums and the matrix in which they exist, Balance and Imbalance of fulcrums, Dimensional Variation inherent in these items building dimension from non-dimensional ct1 to black holes, Resonance (the intersection of fpix and n/fpix where n is an integer), Base numbering Transitions, resulting Matrix Composition, forces as net compression and decompression, Fuse Length, evolving Curvature, inflection points inherent in shifts of fractal mathematics, tendencies towards or away from compression resulting from fractal changes within the fractal matrix, particularly those tied to fuse length changes and averages of those, shifting center points for resonance and overlaps, and the various stable and unstable separations inherent in fractal solutions. (d) manipulating at least one of the identified KFE parameters; and (e) observing at least one change in the target dimension towards the desired state as a result of the manipulation of said KFE parameters.

This can be used to enhancing energy or force conversion efficiency in a system comprising: (a) identifying energy conversion pathways along fractal lines defined by KFE within the system; (b) determining a set of KFE parameters associated with said energy conversion pathways, wherein said KFE parameters listed and optimizing the system to align with the identified KFE parameters.

This can be used for improving material properties in a material comprising: (a) identifying a desired material property to be enhanced; (b) determining a set of KFE parameters associated with the material's atomic or molecular structure, wherein said KFE parameters and (c) manipulating the material's structure to align with the identified KFE parameters which includes this for reaction qualities of multiple materials added together.

This can be used for controlling a complex system comprising: (a) a sensor configured to monitor the state of the complex system; (b) a processor configured to: i) analyze system data using KFE parameters, wherein said KFE parameters; identify deviations from desired system behavior based on the KFE analysis; and generate control signals to adjust system parameters to correct the deviations. This may include an actuator configured to implement the control signals to adjust system parameters based on KFE principles.

This can be used for designing a novel material with enhanced properties comprising: (a) defining a set of desired material properties; (b) selecting a set of KFE parameters that are predicted to result in the desired material properties, (c) designing a material structure based on the selected KFE parameters; and (d) synthesizing and characterizing the designed material to verify its enhanced properties.

Embodiments of the present disclosure include various steps, which will be described below. The steps may be performed by hardware components or may be embodied in machine-executable instructions, which may be used to cause a general-purpose or special-purpose processor programmed with the instructions to perform the steps. Alternatively, steps may be performed by a combination of hardware, software, firmware, and/or by human operators.

Embodiments of the present disclosure may be provided as a computer program product, which may include a machine-readable storage medium tangibly embodying thereon instructions, which may be used to program the computer (or other electronic devices) to perform a process. The machine-readable medium may include, but is not limited to, fixed (hard) drives, magnetic tape, floppy diskettes, optical disks, compact disc read-only memories (CD-ROMs), and magneto-optical disks, semiconductor memories, such as ROMs, PROMs, random access memories (RAMs), programmable read-only memories (PROMs), erasable PROMs (EPROMs), electrically erasable PROMs (EEPROMs), flash memory, magnetic or optical cards, or other types of media/machine-readable medium suitable for storing electronic instructions (e.g., computer programming code, such as software or firmware).

Various methods described herein may be practiced by combining one or more machine-readable storage media containing the code according to the present disclosure with appropriate standard computer hardware to execute the code contained therein. An apparatus for practicing various embodiments of the present disclosure may involve one or more computers (or one or more processors within the single computer) and storage systems containing or having network access to a computer program(s) coded in accordance with various methods described herein, and the method steps of the disclosure could be accomplished by modules, routines, subroutines, or subparts of a computer program product.

### Terminology

Brief definitions of terms used throughout this application are given below.

The terms “connected” or “coupled”, and related terms are used in an operational sense and are not necessarily limited to a direct connection or coupling. Thus, for example, two devices may be coupled directly, or via one or more intermediary media or devices. As another example, devices may be coupled in such a way that information can be passed there between, while not sharing any physical connection with one another. Based on the disclosure provided herein, one of ordinary skill in the art will appreciate a variety of ways in which connection or coupling exists in accordance with the aforementioned definition.

If the specification states a component or feature “may”, “can”, “could”, or “might” be included or have a characteristic, that particular component or feature is not required to be included or have the characteristic.

As used in the description herein and throughout the claims that follow, the meaning of “a,” “an,” and “the” includes plural reference unless the context dictates otherwise. Also, as used in the description herein, the meaning of “in” includes “in” and “on” unless the context dictates otherwise.

The phrases “in an embodiment,” “according to one embodiment,” and the like generally mean the particular feature, structure, or characteristic following the phrase is included in at least one embodiment of the present disclosure and may be included in more than one embodiment of the present disclosure. Importantly, such phrases do not necessarily refer to the same embodiment.

Exemplary embodiments will now be described more fully hereinafter with reference to the accompanying drawings, in which exemplary embodiments are shown. This disclosure may, however, be embodied in many different forms and should not be construed as limited to the embodiments set forth herein. These embodiments are provided so that this disclosure will be thorough and complete and will fully convey the scope of the disclosure to those of ordinary skill in the art. Moreover, all statements herein reciting embodiments of the disclosure, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those of ordinary skill in the art that the diagrams, schematics, illustrations, and the like represent conceptual views or processes illustrating systems and methods embodying this disclosure. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this disclosure. Those of ordinary skill in the art further understand that the exemplary hardware, software, processes, methods, and/or operating systems described herein are for illustrative purposes and thus, are not intended to be limited to any particular named.

One or more embodiments are directed to fractal-based systems and methods (hereinafter may also be termed as “mechanism”) for optimizing matter, energy, and data manipulation. According to harmonic theory, the 4\hat{ }n survives as the positive values (4,16) of 2\hat{ }n giving rise to the prominence of 4/sum(fpix) and observed forces (1,4,8,12,16). One may think of the two versions of offset spirals as those with both positive and negative components resulting from real numbers −1\hat{ }even; vs. those offset curves that have either positive or negative components (−1\hat{ }odd). This is comparable to the positive fpix values giving rise to the noble gases and the odd values giving rise to the semiconductors in the PTE. The second part of fpix includes dealing with 2x (−1) \hat{ }x−1 and is doing the work of creating the two offset spirals in the denominator, the first part (−1\hat{ }x) represents tying the real and bizarro world together. The iterated equation 2x\hat{ }(1−x) is the information bit on which the universe builds. Further, the first part (−1\hat{ }x) then ties the building equation together with a band to get resonance (including resonating between x and x increased by 2 and changed in sign), and compressive structure. The disclosed mechanism encompasses various embodiments that utilize Key Fractal Elements (KFE) for manipulating matter and energy through advanced fractal modeling. The disclosed mechanism is configured to apply fractal mathematics to optimize scientific data analysis across multiple disciplines, including physics, chemistry, biology, and engineering.

In an embodiment, the disclosed mechanism employs fpix equations and MI-based Fibonacci sequences to model and predict the behavior of complex systems. Such equations and sequences define transitions between different states, incorporating a golden ratio to reflect the interconnected nature of fractal structures. Further, the disclosed mechanism also utilizes reciprocals of elements, resonance patterns, and a compression equation 2 f(x)\hat{ }2x to describe exponential growth and compression in the modeled systems.

In an embodiment, the disclosed mechanism focuses on the application of fractal modeling in energy conversion and management. Further, the disclosed mechanism includes designing semiconductors that convert radiation into electricity using fractal patterns. Materials such as lead (Pb), tin (Sn), and their hybrids are optimized for energy transfer based on fractal modeling. Furthermore, the disclosed mechanism enhances nuclear fusion and fission processes by stabilizing reactions and improving energy release through the design of radiation matrices and fission chips that incorporate fractal-layered structures. The disclosed mechanism also extends to Artificial Intelligence (AI) systems where fractal modeling is integrated into the AI to convert empirical data into fractal-based representations. Such an integration allows AI systems to predict chemical and biological functions with greater accuracy and efficiency. Accordingly, the AI software generates fractal models that predict transitions between energy and matter, refining these models based on real-time feedback and discrepancies with empirical data.

In an embodiment, the disclosed mechanism applies fractal modeling to optimize chemical and biological processes. Fractal overlaps of molecular states are used to predict reaction kinetics and design more selective and efficient chemical reaction pathways. In biological systems, fractal patterns are used to predict behaviors and optimize biological processes based on transitions captured through fractal modeling. In an embodiment, the disclosed mechanism addresses quantum and computational systems by involving the analysis and manipulation of information states using fractal-based dimensional features. Such an approach improves the stability of quantum states and enhances computational efficiencies in quantum computing by leveraging fractal-defined transitions. In an embodiment, the disclosed mechanism includes the versatility and applicability of the KFE in various scientific and technological domains. By providing a rigorous, fractal-based framework, the disclosed mechanism enables precise modeling and manipulation of complex systems, leading to advancements in scientific research and technological innovation.

In one embodiment, the disclosed mechanism involves translating any desired outcome into the FIP model, which allows processes to be executed more efficiently through the capabilities of this new model. Such an embodiment emphasizes substituting prior art modeling with FIP modeling, thereby gaining a more profound understanding and modeling of features through the unique perspective offered by the FIP model. Technologies such as fission, fusion, and computing are interpreted through the fundamental process of compression and decompression at the core of these terms, maximizing reaction efficiency and the control of information absorption and release. Another embodiment of the present disclosure highlights the application of the KFE across various scientific fields, including fusion, fission, chemistry, polymer chemistry, hydrogen extraction, electronics, batteries, quantum computing, and AI. This embodiment utilizes KFE to interpret and categorize matrices of CT states, applying FIP to understand and control changes within these states. The KFE iterated equations include fpix, observed ubiquitously in curvature, and MI, observed at higher compression levels, described mathematically through equations like 2f(n)\hat{ }2n.

In an embodiment, the present disclosure addresses the rule of 4's in resonance, with fpix modeling inverse relations that give rise to curvature. The base FIP transitions govern matrix compositions and interactions, encompassing a wide range of structures from spatial to biological. Such an embodiment includes the integration of concepts such as CT states, fpix equations, MI-defined spirals, and pretime change characteristics, among others, to balance and manipulate forces and energy at different dimensional levels. In another embodiment, the present disclosure focuses on the dimensional variation enabled by KFE, which controls absorption and spew generation within CT state matrices. This control allows for the strategic design of machines and reactions, optimizing the points where absorption and spewing occur. An additional embodiment involves the KFE fulcrums, targeting fulcrums and associated stepped transitions that balance information within matrices. Such an embodiment illustrates how fractal spirals align and transition, influencing quantum states, energy systems, and reaction kinetics. In an embodiment, the present disclosure categorizes the KFE into groups, such as fractal elements of CT state transitions, absorption and spew of CT states, and fractal elements in AI and quantum computing. Each group highlights specific applications, from energy conversion to signal processing and molecule design, demonstrating the broad utility of the KFE.

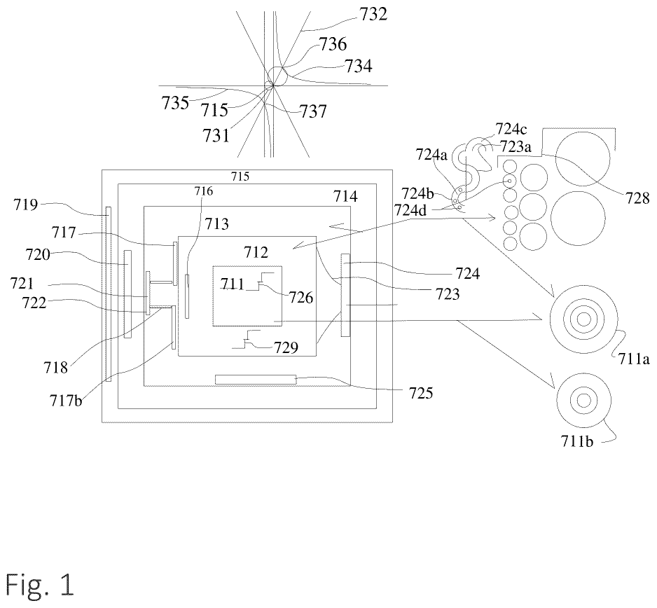

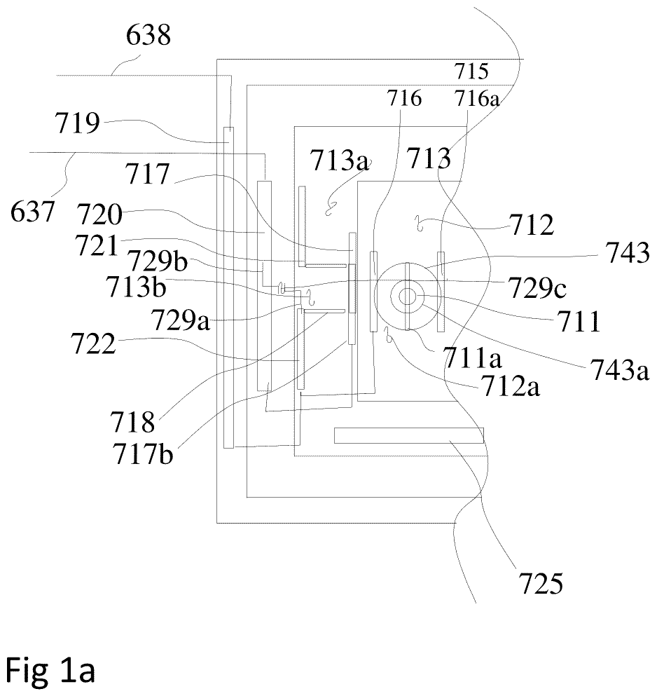

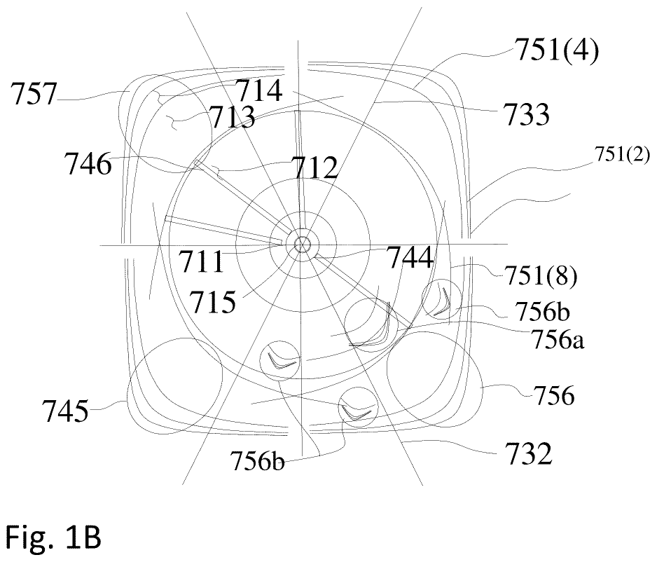

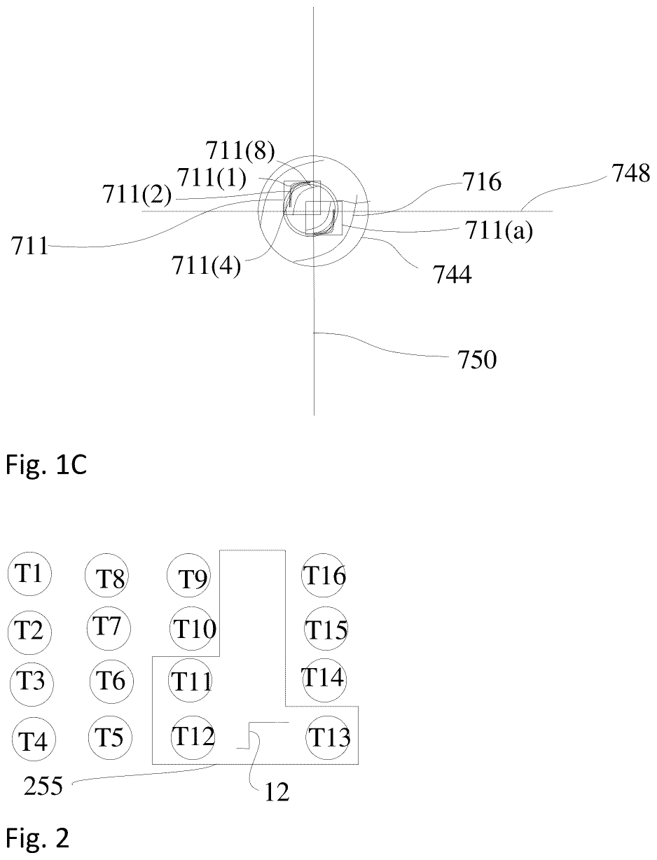

Referring to FIG. 1 through FIG. 1c the curve 734 can be used as a geometric point of reference to encapsulate a surface, radiation source 711, coated with radioactive material. To understand the best way to design this, reference is made to FIG. 1c which shows a close-up of item 711. Item 711 can be thought of as the cross section of a tube although the exact shape can vary. Multiple layers of potential within different layers are used with fractal modeling of energy as pretime change to slowly bleed off potential including those which were too high to deal with using non-fractal modeling. Because any energy, no matter how strong and no matter how much mass is associated with it can be broken down into fractal elements changing according to quantum transitions, any can be controlled as indicated in this exemplary discussion.

Resonance provides stability which can be targeted (building stability or breaking it down) and resonance top 736 shows resonance between fpix plot line 732 and positive y curve 734.

The size of the radioactive area needs to be defined as a part of the 2\hat{ }n framework.

The origin of force shown in FIGS. 19,19a and 22 are important because, 1) you can see them and 2) for chemistry or fission, you can use this for shaping and separating chemical, electronic, and radioactive features to change its internal potential and design transitions. This reflects the two features of −1\hat{ }odd and −1\hat{ }even (−1 and 1 being the effective results).

FIG. 1c shows how instead of a single layer of radioactive material, 2 offset reciprocal layers 711 shown as two sets 711(8), 711(4), 711(2), and 711(1) corresponding in shape and layout to the sets of curves positive y curve 734 and negative y curve 735, but inverted, hence the term reciprocal. There are two sets of these radioactive layers 711 and 711a, the two being the same in this case but offset as in other figures by a diagonal through the offset y axis 750 and the x axis 748. These 1/fpix shapes and their inversion reciprocals allow for the resulting radiation from layers 711 and layers 711a to be focused as much as possible relative to the semiconductor layers shown in FIG. 1b.

To prevent crowding only two of the 4 offset spirals corresponding to the 4 in FIG. 19 are shown in FIG. 1c. What is important is to use the compressive and decompressive geometry to maximize the efficiency of transitions.

FIG. 1c shows the fission generation layout. FIG. 1b shows the preferred layout of the layers to capture radiation from FIG. 1c. This shows the same basic structure of 711, but instead of being coatings at or within radiation sources 711 and 711a, layers of the same shape and designed around the core radius of radiation source 711 are used to take advantage of the strength of the radiation as it transitions from its maximum at the surface of time 711 to the outside of the invention shown in FIG. 1, represented by curves 751(1), (2), (4) and (8) and inverse 745 and corresponding sets of curves 756 and 757.

Because lead and tin are potential semiconductor materials used, it may be necessary to have channel 746 of less dense semiconductors (such as Silicon) within the denser semi-conductor layers which can run from the beginning of the lead layer 744 as far as the end 745 of the semiconductors encasing the radiation source 711. This channeling can be augmented, as with a cathode material near the radiation source and a nickel anode source nearer to the end 745. The importance of this is that with fractal modeling heat can be removed more efficiently and may be part of the energy generation process. It might even include gases, such as noble gases to allow effective migration of electrons, and to do it efficiently all the elements need to be placed using the geometries defined by the model presented.

Rounding out the origin of fpix:1/fpix resonance is the graphing of fpix itself, which can be seen as a jagged line (1, −3, 5, −7), but if you go negative, these jagged lines can be reduced to a cross- or x-shaped plot formed by the intersection of fpix plot line 732 and inverse fpix plot line 733.

Items 732 and 733 can be used as target inflection points to insert or take off energy for different purposes as an example of using fpix features for manipulation. These figures show fractal transitions define pathways to manipulate energy. Curved items 734 and 735 for example and 2\hat{ }n circles define inflection points, energy transitions, and transitions between dimensional states of information. If the curved items 734 and 735, for example, are used to collect energy, the wires to create potential could follow items 732 and 733 for example.

Using the form shown in FIGS. 1-1c, cladding can be along the offset y and x axis to avoid the curved radiation coatings and receptors for fusion, but for fission, gaps must be provided, here by truncating the layers 712-714 beginning, respectively, at exterior reciprocal curves 751(8), 751(4), 751(2) and ending at item 745 which in this case would correspond to 751(1). Note that additional layering can be added, although it would increase exponentially the distance, item 715 times 16, instead of the radius of item 715 times 8 between the first layer here item 751(8), and the radiation source 711 if the fractal decompression was maximized. This is a mirror image relationship to that shown in FIG. 19, so the relationship in terms of spacing between the curves is the same as in FIG. 19, but opposite. That is, instead of 1,2,4,8 from inside out (based on separation item 715), it would be 8, 4, and 2,1 from inside out.

This extension can be continued, for example, in FIG. 19 indicator 747 shows the diameter to resonance 730(16) which would be the next curve out from the series that ended at 730(8) based on the 0.5 offset 738.

If FIGS. 1b and 1c are treated as a tube, it would be desirable to stop the radioactive material before you get to an end of the tube defining the radiation source 711. Source 711 can be hollow, although the layers of radiation are preferably attached to a surface or embedded within a solid.

While a spherical source 711 might be useful the amount of overlap of the semiconductor layers is higher and for ease of visualization this simplified view is used.

Force, of which energy is an example, is defined by stepped compression along fractal lines. In this case, Mega-watts of energy are merely watts of energy involving exponentially more ct1 state change, manifested at the ct4t12 level, the level where the electron-photon interaction occurs. The specifics of the level where transitions occur can be varied since it is a fractal perspective stepped the same way mathematically whether you are dealing with ct1 or ct4 states or higher.

In terms of energy, this is a function of the pretime change (resulting in wavelength) and Planck's constant, in this case, the constant is essentially a feature used to separate pre-time change from post-time change, where we cease to see things since we use photons as the way to view net pre-time change. The transitions from a quantum pretime change (ct1 changing from plus to minus in value) is a fpix quantum solution and hence all pretime changes at any level can be defined as ct1 changes and targeted based on these changes and along the fractal winding and unwinding lines taught.

Nesting, as sown with items 756b can include not just the primary steps, the 14 (assuming base 14 architecture) shifts in addition to the more stable 1-4 divided by fpix shift. These size changes target different radiation features, scattered individual units instead of one large one or in addition to one large one.

Potential may target different positions during the process so that different layers. Looking at FIG. 1a, you can have the N layer at item 717 and the P layer may shift between items 721, 722, and 719 by way of example to change the potential. Om FIG. 1B there is another example where Potential can shift between scattered units e.g. different 757b units or 756b and 756. It is also important to note that the arrangement of item 756b should be in accordance with the fractal distribution of information. These shifts may be triggered by the type of information passing through item 713.

Unlike traditional Semi-conductors or thermocouples, the potential is exponentially greater giving rise to higher voltages, but also making the transitions higher than are otherwise available. The energy in many cases is more concentrated around the high energy particles, which is the energy in heavy particles, representing the pretime change of the states within those high energy particles, is not only high but concentrated and bound so that it must be drawn out. Having FIP-designed bubbles, in fractally relevant materials, within the various layers can focus on pretime change from individual particles. Whether these create a metal foam, a semiconductor foam, or a foam of one material inside another, this is another way of approaching t. transition of the information into a usable wavelength where heavier particles are involved and the same modeling shown for item 711 can be copied for this purpose around or within the various P-N layers for providing absorbing information states and to change those into the usable form for the absorbing layer.

Referring to FIG. 1, different features of fractal modeling are available including the layout of overlapping spirals to go with the filtering and collection systems otherwise following fractal equivalents along with transfer PN layers of varying types to charge varying carriers and focusing on positrons as holes which can be manipulated and arranged to increase flow efficiencies in any solar or thermocouple type transfer and opposing charge areas and the like.

FIG. 1 stuff: Each layer can be spherical or flattened into a circle to reflect the two-dimensional nature of pre-neutron modeling, different layers with different levels of purity and with doping (using fractal design of both the doping materials and how they are included, are ways of modeling of the layers within one another to define desired fractal transitions. All fractal features are based on the FIP specifics set out herein and while terms like shape, purity, different radioactive, and non-radioactive elements are terms of the prior art, reducing all features and goals to FIP elements allows energy a new, mathematical as opposed to intuitive approach.

Simple layering, as opposed to layer with purity for radiation shaping, is shown based on 2\hat{ }n in items radiation sources 711b and as MI modeling in shaped radiation sources 711a and 711c.

For conducting layers, it may be necessary to insulate them from one another and conductors allowing for the circulation of the current. Because we can see the individual layers in fission as being filled, it may be that beginning within the filled area of the 2\hat{ }n layers, to a next insulation areas 743 and 743a. Insulation area 743 is shown here to encompass at least part of the items 712 and 716a Insulting area 743 may be the filled area of another layer to have the best drop in potential and hence the location of the P-N layer separation. In this case, item 743a is designed to dissipate heat buildup using FIP modeling laid out in this specification.

The order of layers, the concentrations, and percentages can be calculated with some specificity depending on the source of energy using similar concepts to traditional energy exchanges but modified to recognize the nature of the transitions as fractal and based on the equations for pre-atomic and atomic fractals. The locations and angles are based on the size and shape of a radioactive source, items 711, 711a, and 711b which are also designed to focus the information and type of information interacting with the rest of the features in FIG. 1a. For this reason, we might have multiple layers of lead SC 712, and the locations of the P-N layers (or fractal equivalents) as well as their separation may be modified to reflect the nature of the energy transitions and the high potential changes. For the sake of simplification, the layers are presented showing 2\hat{ }n transitions and in the order of concentration inherent in their construction. There is the Pb (lead) layer(s) 712 which can have multiple 2\hat{ }n, fpix, or MI-based transitions, each having semiconductor placement at different places within the layer(s) and the same for the Tin (Sn) semiconductor 713, the Ge SC 714, and likely others as the energy is broken down, concentrated and/or focused and separated within the framework. Unspecified layers 715, could be reflective in that they have strongly filled fractal constructions or absorbed like lead or composites, such as Pb—Si or Sn—Si.

There are semiconductor buffers 716 which reflect the ability to absorb different layers of energy, thereby decreasing the levels with, along with first offset SC 717, and second offset SC 717b also absorbing energy at specified levels so that the chamber formed by the perpendicular SC(s) 718 (the exact angle(s) would reflect the FIP modeling and, in this case, 1×SC 721 forming a chamber (the number of items 718 on all sides is likely, to reflect and absorb energy (CT states of various energies) and allow for the separation and concentration maximized by FIP modeling.

The depth and width of the semiconductors within and between layers is reflected by 3×SC 719 and 2×SC 720 which take the filtered radiation and continue the process, forming potential separation layers between them to maximize the yield. The electrical change between any two P-N type layers, such as item 719 and item 720 are circulated by P conductor 637 and N conductor 638 running outside of the figure to where energy is stored or used.

Channeling occurs through the interchange of CT states inherent in all matrices and for this reason, given the modeling for overlapping spirals, there are overhanging SC elements 722 envisioned as well as having them offset. Similarly, the density of materials and structures can be used to form funnels 723. This is another example of how the concentration of materials can make the net effects better for the results. In the case of scales 2, 4 and 8 reflected in radiation source 711, for example, these might reflect changing concentrations of U235 so that the higher energy-producing results may be external (higher 235 concentrations between 4 and 8) of internal (higher concentrations within item 2 or variations, such as pockets of concentration to control the direction (like the funneling) and quantity of CT states for this purpose.

While the example of item 711b is used here, using item 711a or fpix modeling can be used. In the case of fpix modeling the negative.

Reflective SC 724 also embodies the idea of more radiation-absorbing/reacting material to build CT state creation at different locations within the matrix.

Offset SC layers 725 reflect a broader separation concept. This applies to where potential may be drawn off as well as to take advantage of the relative positions of CT states circulation of and within the various elements addressed.

F-series spirals 729a and 729b with an area of potential 729c between there they would otherwise overlap can be used to provide an interim connection between overhand sc 722 and 2×sc 720.

There may be the absorption of the spew of information based on the alignment of one or paired spiral arrangements 732, exemplary being silicon P or N layers aligned at MI-based spirals of varying sizes and here sown as overlapping spiral layout 726 of item 711 to absorb information coming off the 2\hat{ }n circles or spheres or directly from the radiation source.

2\hat{ }n nesting 728 in series as opposed to the nesting internally 711a and 711b and the semiconductor material as nested 2\hat{ }n squares in FIG. 1.

Resonance 730 is shown as a dimension arises based on the center of an x/y axis 738 of the initial two-dimensional framework. Fpix resonance 730 results from the 0.5 offset of fpix solution line 732 and the resulting inverse (1/fpix) association 733 which results in a positive y curve 734, negative y curve 735 and the resonance top 730 and resonance bottom 737, there being mirror image resonances for all the (1), (2\hat{ }n) versions of items 734, 735, 754 and 755 which results from the intersection of line 732 (for item 734 and 735) with curves 734 and 735 and line representing 733 (for items 754 and 755) which is later reflected in the overlapping spiral form.

FIG. 1a shows one side of this arrangement. The two sides can by p-n mirror images to increase potential. Conceptually you would have higher concentrations (even solid layers or blocks) of doping (absorbing type) the closer you get to the radioactive material. The idea is to peel off the lower-end pre-time change with whatever can separate it and create a potential that can be drawn off and provide a mechanism to draw it off. It might be necessary to have “tubes” of lower order (e.g. C or Si or Ga) semiconductors, possibly even with embedded conductors to allow the potential to move from the thicker layers of doping agents and associated conductors (e.g. copper wire) to the next layer (connected in series, for example) to allow the flow of electromagnetic features to where they can be transferred as the potential builds.

Multiple layers would be close enough together to allow transitions with lesser amounts of doping or more conductive semiconductors.

The right semiconductor and KFE structure (physical and chemical) can break down or build up to a desired energy and potential and provide for effective producing a solution of photons, positrons, and electrons with focused or enriched pretime change from dissolved bonds of atoms and molecules creating a fluid matrix from an overly fluid and overly solid features.

Direct transitions between fission and electricity focus on low-wavelength thermocouples. The alternative we address will focus on high-energy particles by developing a lead (Pb), tin (Sn), or lead/tin hybrid semiconductor (solar cell equivalents) in conjunction with other SC (Fl, C, Si, Ge and hybrid semi or partially functional conductors).

In an embodiment, a method for cold fission, where fractal modeling allows the direct conversion of radiation into electricity. By scaling small processes using larger-scale fractal equivalents and transitioning across scales, the invention defines a process that captures and reorganizes energy through filtering, transportation, and application of materials. Fractal equivalence enables the modeling of energy transitions, atomic structures, and potential separation at optimal matrix locations. In an embodiment, the transformation of radiation uses a fractal approach akin to breaking up a landslide of ice into manageable parts, using filters and heat to accumulate and convert it into usable energy. This process involves semiconductor layers doped to hold and transfer photons at selected pretime change rates, mimicking a generator's potential generation.

In an embodiment, the present invention also encompasses a method for using round or shaped atom layers with embedded fractal matrices. These matrices separate pretime change at desired levels, employing elements like Tl and Bi alongside Pb semiconductors for photon absorption. The solar cell analogy is extended, where photons excite electrons within the semiconductor material, initiating electron flow through the n-layer. In an embodiment, the present invention emphasizes the utility of fractal elements in improving the direct transition from radiation to electricity. By leveraging fractal atomic resonance and pretime changes at various levels, the invention provides a sophisticated method for energy modeling and conversion. This process includes assembling fractal elements to design molecules, polymers, and fusion processes, enhancing efficiency through targeted fractal transitions and fulcrums. Additionally, the present invention includes the concept of using f-series spirals as scoops to increase potential. These spirals, arranged along fractal lines, facilitate the manipulation of energy at the atomic and molecular levels, optimizing the arrangement and doping of PN layers or equivalent materials like lead-tin alloys.

Using fractals with data science to modify AI software to maximize the accessibility, organization, and value of empirical data. Dealing with the complex variations such as what appears essentially infinite variation in life requires AI and AI requires a base structure, underlying algorithms which can tie everything together to avoid chaos. One can cross-characterize existing, empirical non-fractal data within sub-atomic, atomic, chemical, and biological data with fractal data required by the “AuT” Fractal modeling used to define any features at any level of dimensional existence based on fractals effects within the matrices under consideration. Categorization is a broad way of describing design by breaking into fractal elements one or more of the following: chemistry (reaction; fuel; carbon capture; rare earth combinations) based on fractal chemical and molecular structure of the at least one matrix; biology (DNA, ATP, biological design, and function); physics including titanic event prediction and control; quantum gravity and time, black holes, dark energy, wave-particle duality, etc.); Energy capture, generation, and storage; fission; Quantum Computing using the non-pretime change and pretime changing with non-pretime changing or amount of pretime change to deliver or withhold information; Concentrating pretime elements; qubit function and design utilizing key fractal elements (KFE). CT states are an example of KFE as is quantum change which with the CT states creates pretime change for relative work.

Fractal modeling “integrate(s) multidisciplinary” information because the same fractal model applies to all dimensional features of the universe and even pre-dimensional features that energize the universe. AuT includes treating AuT fpix changes as plus and minus. There are multiple ways in the electronic spectrum where the plus or minus result can be sampled or applied with fuse length, compression vs decompression; abs vs spew; pretime, and post-time change. The absolute definition of change at ct1 is a quantum count common to all points in the universe, “absolute time” or more accurately “absolute change” or “AuT dimensional change.” This allows energy, even time, to be viewed as just another fractal change within a quantum fractal system. Despite exponential complexity at different compression levels, fractal means there are equivalents at every level. Larger atoms mimic galaxies in structure a concept that is the result of a mathematical analysis, not theory. All of the different manifestations of change and those that result in energy changes can be treated as fractal matrix changes reflecting average pretime change. The work includes: 1) identifying the fractal patterns that should be associated with the data (2) looking for fractal patterns at all levels (energy, pre-energy, structural, component, environment, etc.) (3) processing at least by categorization of the data based on fractal modeling. In chemistry fractal components and reactivity, elements have been identified based on confirmed, but unrefined fractal mathematical features. These features are the baseline fractal structure which can tie everything together to avoid chaos.

Energy and Radiation viewed in the context, force in general and Energy in particular are represented as the transitions between different states, broadly defined by 2f(n)\hat{ }(2\hat{ }n) transitions where f(n) changes between fpix and MI. Forces arise from these transitions, confirmed by comparisons to observations and explanations of otherwise unexplained phenomena, such as time, magnetic attraction, and the relatively weak force of gravity. Gravity is the folding of individual solutions to fpix, called ct1 states, folded into ct2 based on the equation 2f(n)\hat{ }2(n) for n=1 and f(n)=fpix (1, −3, 5, 7). Carbon's electron shell and proton count reflect 2*f(pix), where n=4. At neutron bonding, the geometry shifts, so in the case of atoms they can be defined below the level of neutrons based on fpix, and above the level of neutrons by the neutron backbone defined by overlapping MI spirals. Force can be defined as interactions between matrices of different “compression” states as observed from the standpoint of time. Time and its relationship to energy in various forms can be seen as a form of stop-frame animation for compression states at and below the level of photons, those below the level of photons being impossible to observe using electromagnetics because they occur below the level of photons. Magnetism can be modeled as the net transition of “pre-photons” occurring pre-time as viewed from a post-time perspective, acting much as a low-pressure system. Waves reflect pre-time changes in position as viewed from the perspective of time. At any quantum moment, the photon is the particle of “wave-particle” duality.

For modeling, force is defined as interactions in quantum terms between matrices of different “compression” states (ct is the nomenclature used). Time and its relationship to energy in various forms can be seen as a form of stop-frame animation for compression states at and below the level of photons, those below the level of photons being impossible to observe using electromagnetics because they occur below the level of photons. Magnetism can be modeled as the net transition occurring pre-time as viewed from a post-time perspective. Waves reflect pre-time changes in position as viewed from the perspective of time. At any quantum moment the location of the photon is frozen, the particle of “wave-particle” duality. In this model, bonding forces come from shared information, energy results from the release of this shared information based on specific iterated equations, and bonding or un-bonding results from inherent features in the underlying equation. In a single amp, there are 6.24×10\hat{ }8 electron flow per second. Under this analysis, there would be a flow of 6.24×10\hat{ }8*14 photons, and each photon would have pre-photons (ct4t12 states) which in turn would have pre-pre photon states (ct4t11) and so on.

While this remains approximately the same over long periods of what we call change, the ratio does change because at any point in the universe, the transition from net compression to decompression (and for the universe as a whole) changes over time. And time can be viewed in more absolute terms as a quantum change in a quantum count. As a system accelerates relative to its localized baseline, the amount of pretime change slows relative to the amount of post-time change reflecting the movement relative to the baseline in place of change within the system slowing down the feature of time. Moreover, at the electron level, waves can be viewed as particles. (photons) being in multiple places at once from the perspective of time (vs. being localized for any quantum change at a specific point) so that the ability to do work (energy) can be viewed as the ability to take a pretime change and use it to move things around in a post time perspective. Energy can be viewed as the availability of pretime change within a system.

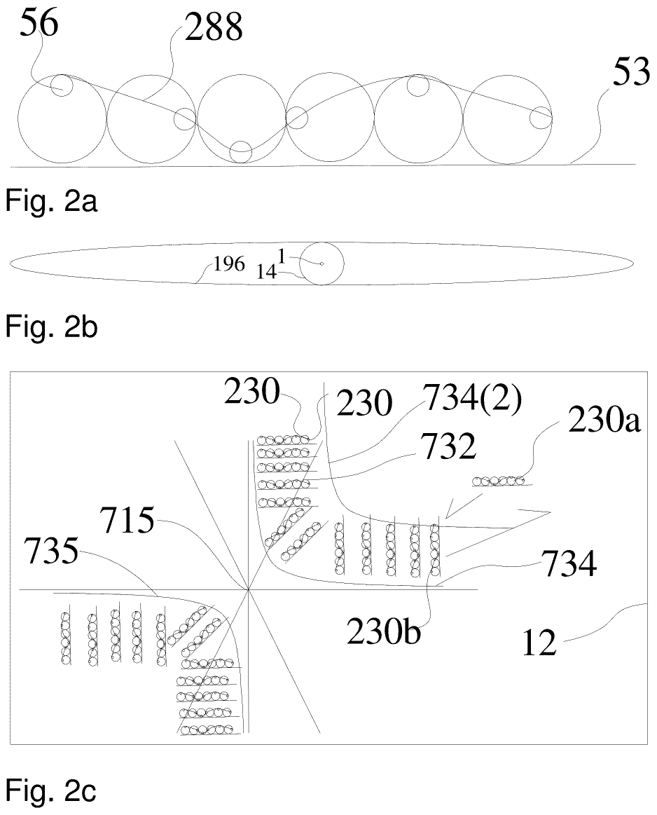

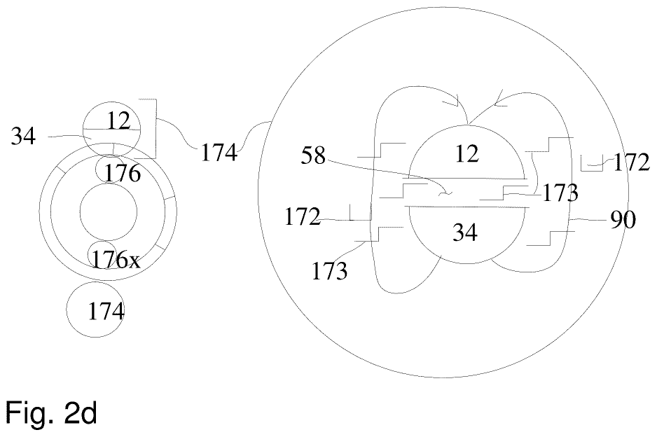

FIG. 2 illustrates a representative view of ct3 to ct4 compression, in accordance with various embodiments of the present disclosure. FIG. 2A illustrates how energy is represented by pretime change of particles, in accordance with various embodiments of the present disclosure. The Archimedes wheel shown above shows how a fixed particle 56 generates a wave 288 as it moves relative to a fixed timeline 53.

FIG. 2B illustrates the relative compression sizes in base 14 (2*7), in accordance with various embodiments of the present disclosure. FIG. 2C illustrates electron structure in base 14, in accordance with various embodiments of the present disclosure. FIG. 2D illustrates a view of plasma modeling, in accordance with various embodiments of the present disclosure. For the sake of brevity, FIGS. 2-2D have been explained together.

In an embodiment, FIG. 2 shows scaling ct3 to ct4 transitions. T1 represents 10 (base 10) or 14 (base 14) ct3 states marking the first step in the 10-step transition to ct4 states, there represented by t16. T2 would have 10 T1 states (base 10) or 14 t1 states (base 14). The electron 12 is somewhere between T12 and T13 although it would have a cloud of lower states around it which is the case for each CT state. Time 255 arises between ct4t11 (T11) and the electron based on stop frame animation effects of all the lower states as perceived from the standpoint of a time-based electromagnetic system of the type we experience. The scales involved are comprehendible as fractal multiples. The transitions build according to an exponential increase whether 2\hat{ }n or a transition between 2\hat{ }n and x\hat{ }n the exponential result for x as a whole number greater than 1 means that there are exponential transitions between CT states. Continuity past ct4 is ensured since ct5 states, black holes are an observed example. Modeling indicates that ct5 states are not just the large structures securing galactic spirals, but that they exist within, or at least existed within, spherical moon and planet bodies giving those their 3-dimensional features. Hydrogen is not “an element” because it does not have a neutron backbone and heavy versions of hydrogen do not have a neutron backbone, even though neutrons are present. Further, a neutron backbone requires two neutrons to share information and be balanced and stabilized by surrounding information states, namely protons and electrons. Furthermore, modeling suggests that protons are ct4t15 states and a special type of positron which is one-half of a ct4t13 state, the other half being the electron. This eliminates energy, space, and time in favor of changes to fpix and compression states related to fpix. Going back to the discussion of SE and Bohr, we are “quantizing” the wave form of electrons as 5.4 ct4t12 states (See 5.4/7; 5.4/14 base) where the 0.4 reflects the ct4t11 (and lower) CT states in the electron matrix. Varying the number of these pretime CT states (each ct4t11 is a quantum photon element.

In an embodiment, FIG. 2A shows how a photon (or pre-photon), in multiple places at once from the standpoint of time appears as a wave generated by the pre-time movement of “Archimedes wheels” (top left). The more change “pretime,” the more compressed the wave form and the more energy it represents. Further, FIG. 2B shows how scales change in base 14 from 1 to 14 to 196 going from level 1 to level 3. The circle for 196 is flattened so it fits in the space provided. In this scale a photon (ct4t13 196) is 1/14th of an electron (top right), the pre-photon element (ct4t12 14) is 1/14th of a photon and represents the electric component, the pre-pre-photon (ct4t11 1) is responsible for the magnetic component. It is worth noting that there is a soup of these particles and of this soup, at the pre-pre-pre photon (ct4t10) there are 2744 ct4t10 states reflected from this soup in a single photon, and other ct4t10 states would be around the photon. Further, time and pretime diverge at the photon, so “energy” represents pretime change at the level of the photon. In an embodiment,

FIG. 2C shows the electron 12 composed of photons where each wave element 230 (i.e., a photon according to current non-fractal physics and which is a transitional element designated as most likely a ct4t8 state assuming a ct4t12 electron is viewed as the wave form of a particle, item 56 in FIG. 2a, changing before the dimensional effect we view as time. For purposes of categorization as discussed herein, the designation of the bound electron as R4ct4t14 refers to the Fourteen ct4t12 states 230 shown along items 734 and 735 scaled to the electron level. If outside ct4t12 state 230a has more pretime change than internal ct4t12 state 230b and substitutes for it, in whole or in part, it can increase the energy inherent in FIG. 2c moving items 734 out to 734(2). While interim movement between item 734 and item 7342 is also possible, discrete steps likely reflect the inherent stability of resonance in particular stepped transitions.

FIG. 2D shows the resulting effect of charge as the exchange in the direction conceptually shown (spew lines 90) of the ct4t13 173 between electron 12 and positron extending from a proton. In an embodiment, the unbound electrons as “electrons” and they are one-half of the “bound electron”. Also shown just for perspective are ct4t14 states 174, ct4t16 states 176 which are likely protons or neutrons. The electron alone is 7 ct4t13 states of the total of 14 ct4t13 states in the bound electron. The circulation of pre-photons around the photon when viewed from the standpoint of time creates the effect of magnetism and functions like a hurricane-low pressure system which is a fractal equivalent. In this case, relativity is the relative amount of pretime to post-time change in a matrix. The ability to do work (energy) can be viewed as the ability to take a pretime change and use it to move things around in a post-time perspective. Heat is “trapped” within molecular bonds of the matrix, while high energy particles (HEP) are particles with high amounts of pretime change.

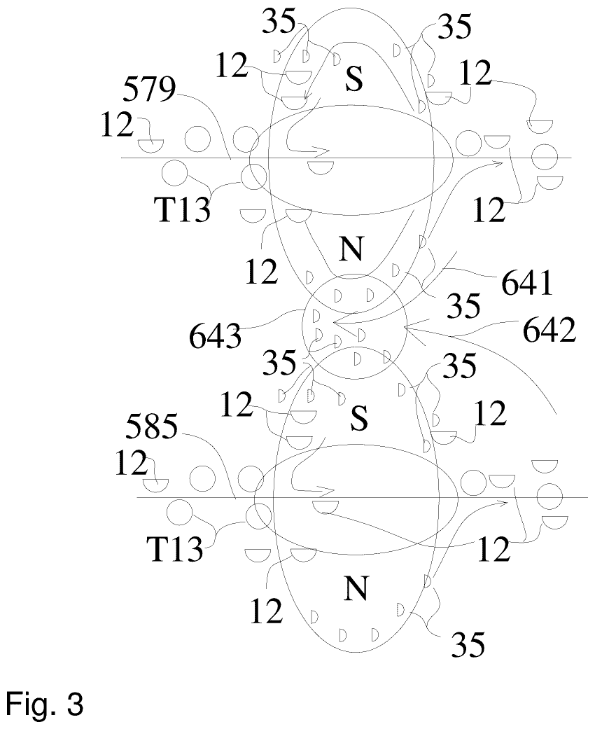

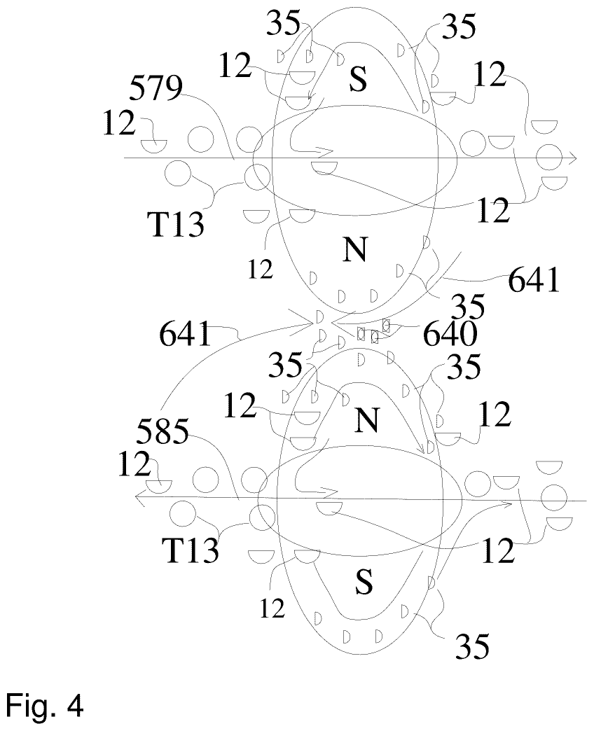

FIG. 3 illustrates a representative view of magnetism from electricity based on fractal modeling and associated magnetic attraction, in accordance with an embodiment of the present disclosure. FIG. 4 illustrates a representative view of magnetic repulsion based on fractal modeling, in accordance with an embodiment of the present disclosure. For the sake of brevity, FIGS. 3 and 4 have been explained together.

In an embodiment, FIG. 3 illustrates how electromagnetic fractal fields appear static between quantum changes, depicting the mechanism of magnetic attraction. In contrast, FIG. 4 demonstrates how magnetic repulsion functions. These figures represent pretime states perceived as magnetic effects and spatial phenomena. Time and pretime change are “frozen” in these figures. From a time-based perspective, electron pairs represented as t13 states appear fixed around the top wire 579 and bottom wire 585. The current flowing through the wire and the lateral movement of electrons 12 at pretime ct4t11 gives rise to magnetic effects, while the ct4t12 states embody the electrical component. The pretime nature of these states means only the magnetic portion of the energy solution is observable. Both figures display electrons as t13 states (T13), which consist of t12 states as electrons 12. Surrounding these electrons 12 are M+ states (35), representing the magnetic ct4t11 equivalent, rotated at 90 degrees and half size, reflecting their exponentially reduced information content (approximately 1/10th of an electron) and their offset orientation, resulting in an elliptical cloud of information around the top wire 579 and bottom wire 585. The separation between the wires and the circulating M+ states indicates the extent of the magnetic field's influence on the current. FIG. 3 shows how electromagnetic fractal fields appear frozen between quantum changes and how magnetic attraction works. FIG. 4 is the same as FIG. 3 except it shows how magnetic repulsion works. We “see” pretime states as magnetic effects and space. Clockwise rotation 641 and counterclockwise rotation 642 are shown.

Time and pretime change are “frozen” in these figures. From a time-based perspective, the electron pairs shown as t13 states would appear largely fixed about top wire 579 and bottom wire 585. Due to current through the wire, the movement to the left or right of electrons 12, a wire and being pretime these mechanical changes at ct4t11 gives rise to magnetic effects, the ct4t12 states are the electrical component. Being pretime, we only see the effects of the “magnetic” portion of the energy solution.

In both figures, electrons are shown as t13 states T13, which are made up of t12 states as electrons 12. Circulating around the electrons 12 are M+ states 35 which are the magnetic ct4t11 equivalent of electrons M+ states are shown rotated at 90 degrees and half size reflecting their exponential information content (approximately 1/10th that of an election) and their offset orientation which leads to the elliptical appearance of the cloud of information surrounding the top wire 579 and bottom wire 585. The amount of separation from the wire to the circulating M+ states magnetic field reflects the extent of the magnetic field portion of the current.

The M+ states rotate around the T12 states pretime and their positions are seen as waves as a result. If we take time out of the mix, we can see that the two cooperating circulations in FIG. 3 make it relatively easy for the M+ states from the bottom wire 585 and top wire 579 to mix, exchange, and the result, comparable to high and low-pressure systems at scale is to draw them together. This is reflected in the area of sharing 643 In FIG. 4, since the path of rotation is opposite for the two flows of M+ states between the top and bottom wires there are collisions 640 which lead to a buildup of these states, from a post time perspective is seen as a magnetic repulsion. The pretime change inherent in the M+ states is what powers the ct4t12 states as they not only circulate but exchange information. Because the ct4t11 states are pretime we only see the net effects as repulsive. Our ability to get post-time “work” from pretime “change” is the energy effect.

In an embodiment, the M+ states rotate around the T12 states in pretime, appearing as waves due to their positions. Removing time from the equation allows the cooperative circulation of M+ states to be seen in FIG. 3, facilitating their mixing and exchange, which draws the top and bottom wires together, reflected in the shared area 643. Conversely, in FIG. 4, the opposite rotation of the M+ states between the wires results in collisions, leading to an accumulation of states perceived as magnetic repulsion from a post-time perspective. The pretime change within the M+ states drives the ct4t12 states, and their circulation and information exchange are the sources of this energy effect. Several factors influence the wave pattern, including the distance of the information flow from the wires, which can be increased and manipulated by coiling the wires, as known in the art of magnetic field generation. Another factor is the degree of pretime change in the M+ states, representing the number of revolutions around the t12 states over a given time period. An increase in rotational speed and movement in pretime results in a shorter wavelength, increasing the energy within a ct4t11-12 matrix. Further, the figure illustrates frequency generation as a particle moves along a pretime length, creating a wave effect when viewed through the lens of time. Energy, in this context, is the capability to harness pretime change in a post-time environment to perform work, expanding the apparent space occupied by smaller particles from a temporal perspective. Energy equates to pretime change, with frequency reflecting energy as the number of pretime changes in ct4t11 rotation about ct4t12. Planck's constant represents the size of ct4t11 states viewed as energy over time. Plasma and its control can be defined by the specific mix of fractal information within a matrix, akin to how an airplane is affected by changing winds from a time-based perspective. Recognizing these circulating structures enables their use in facilitating transitions in higher CT states.

The traditional view of Fission does not consider that all the “energy” in the system abides in “pretime changes” manifested at the photonic level where time becomes apparent as a form of stop-frame animation based on these pretime changes. FIGS. 3 and 4 show that all energy is pretime change which allows us to see magnetic repulsion at the post-time net effect of pretime dimensional levels. This model can be used to increase the output for an electric motor, a goal for phase 2 along with superior shielding from radiation. These equations represent solutions for f(x) in the iterated equation CTx=2f(x)\hat{ }2\hat{ }x, which leads to folding, force, and other emergent phenomena. The relative strengths of gravity and strong force allow a check using the compression equation (2f(n)\hat{ }(2\hat{ }n)) and calculating the results. For MI: Fibonacci (f(n)=1,2,3,5,8,13): For n=2: 2f(n)\hat{ }(2\hat{ }n)=4\hat{ }4=256; For n=5: 2f(n)\hat{ }(2\hat{ }n)=18\hat{ }32=1.47×10\hat{ }40; For fpix (f(n) 1,−3,5,−7,9): For n=1: 2f(n)\hat{ }(2\hat{ }n)=2\hat{ }2=4; For n=4: −14\hat{ }16=2.18×10\hat{ }18 for this step, but the total compression is 1.12905E+30; For n=5: 2f(n)\hat{ }(2\hat{ }n)=18\hat{ }32.

Neither ratio is precise, but if you use fpix for the initial folding element (think boson) to get to fpix and transition to MI for the strong force (n=5, f(n)=8) you get a ratio of 1:8.5×10\hat{ }37 (3.4*10\hat{ }38/4) which matches the observed force ratio of 10\hat{ }38 for the gravity to strong force ratio. The suggestion is that n=5 up to the proton with a base of 2*−7, then shift to n=5 with a base of 2*5 for MI modeling at the neutron. This means the electron would be based at least loosely on a base (photon units per electron unit).

Electron “full orbitals” are 2 times the absolute value of fpix (1, −3,5, −7,9). For fpix values of n=1 to 4. This is two times 1, 3, 5, and 7. The electron count (full shell) matches 2×fpix solutions 2*fpix gives full electron orbitals (2,6, 10,14) just like the Proton count for noble gases reflects 2×fpix solutions, skipping the negatives.

The proton counts for noble gases reflect 2 times the positive fpix solutions (namely, 1, 5, 9 for Helium, Neon, and Argon. The next noble gases' proton counts are multiples of 9 for Krypton (4×9), Xenon (6 times 9), and Radon (10 times 9, but with 4 fewer protons showing the importance of the neutron backbone at these scales). These transitions reflect the positive fpix values up to Argon and then build from the negative fpix values. The initial “noble” change is 1 (2 since there are two spirals); then 5 (10); then 9 (18) skipping every other result in the rush towards noble relationships for the proton count. The 3(6) and 7(14) remain relevant as semi-conductors, shells filled to give stabilized repeatable, connectable with efficient electron state exchanges; the 3 as the 6 unit/carbon-like ring structure.

In fractal modeling, there are no electron orbitals as such to fill. Electrons are associated with and balance the protons in an atom. Balanced layouts and the other fractal features may be targeted for fusion, fission, chemistry, and electromagnetics. Dissolving this balance between the AuT positron and electron gives rise to ionization. Electron orbitals are discrete due to discrete ct4t12 or ct4t11 information exchange. Lower states are too small to show up being 14\hat{ }100th smaller than the forces we use.

Fpix modeling with N=ct4: If we use f(x) for ct4 is 7, then we have a base compression equation. To get an electron of consequence we can use the ratio of ct4t12:t16 which is 2.6×10\hat{ }-5 meaning the electron is 20.89 ct4t12 states which is robust electron compared to the model using 5.4 ct4t12 states (if it were in t13 states it would be 1.5 t13 states). Transitions are base transitions between ct4t12 and ct4t13 and there is no clean transition between 20ct412 states and ct4t13; you already have 1.49 t13 states within the ct4t12 states. Such a “two times” 20.89 ct4t12 unit; ct4t13: 41.78/14=2.98 ct4t13 states. This may be a balanced 1.48:1:48 product compared to a 1.005:1.005. Much of the information is “massless” because it is in the form of energy-equivalent pretime states. The pair would absorb ct4t11 (or ct4t12) from a source which would give it a charge-type exchange (positive or negative).

The ct2: ct5 ratio for gravity to the strong force works well in this scenario. (1296:1.47×10\hat{ }40=1×10\hat{ }37). If the initial ratio is used, it is 14 or 196:1.47×10\hat{ }40, the 196 number working well). We are working in base 7 or if balance is included, base 14. There are 1.49 T13 states and, multiplying this by 14, there are 20.9 ct4t12 states in base 14 fpix mathematics, 3.84 times as many ct4t12 states as seen with base math. A pair of electrons under this fpix analysis would be 41.8 ct4t12 states or 3 ct4t13 states less 0.015 lower information states. One might alternatively call it 2 ct4t13 states plus a cloud of almost one ct4t13 state's worth of ct4t12 and lower information states. Keeping in mind that this is a base system, this lower information represents 7.03 ct4t12 states. If we look at what happens if we ignore the 0.4, the shadow of lower CT states around the 5 ct4t12 states, instead of 5.44×10\hat{ }-4. This is 5.438806×10\hat{ }-4 in the calculation and is the measured mass of the electron divided by the measured mass of the neutron which is complex because much of the information stabilizing the electrons is considered without mass. Using 5×10\hat{ }-4, the resulting measurement (0.0005×14) is 0.007. When you average these two results you get 7.30716×10\hat{ }-3 as the electromagnetic effect, an average between the pure ct4t12 and ct4t12 plus lower state effects. This is 99.8657% of the same result using the non-fractal morass of equations used to calculate the fine structure constant (FSC).

The problem with shifting base numbering is that we must derive it from observations consistent with the modeling. Full ct4t12 pairing gets a ct4t13 in base may be cleaner than a pair of t13 states, but we also have the evidence of Helium equivalence to paired t13 states. Full shells appear as t13 pairs in the 1.45:1.45 analysis. The evidence includes the resulting similarity of the electron to the fine structure constant and fpix pairing numbers. This is the process of using the fractal design, categorization, and use of features that we have. The electron viewed as paired T13 states with clouds of ct4t12 (and lower) can find a fractal counterpart in paired neutrons in helium. Neutron MI spiral folding reflects the overlap where fpix folding gives way to MI overlapping spiral folding yielding solutions in the “calculated” column below. If you measure the length of the spirals that have been confined by the Fpix-defined circles, the lengths yield the neutron count for the first 3 lines of the PTE. Multiple other features of atoms are apparent, and the F-series ratio of protons to neutrons established are maintained for all subsequent atoms. The initial “noble” change is 1 (2 since there are two spirals); then 5 (10); then 9 (18) skipping every other result in the rush towards noble relationships for the proton count. The 3(6) and 7(14) are relevant reflecting semiconductors; the 3(5) as the 6 unit/carbon-like ring structure. The visible transition from Fpix to MI in equation 2f(n)\hat{ }(2\hat{ }x) occurs at the proton to neutron fusion location and is visible in atomic and post-atomic structures.

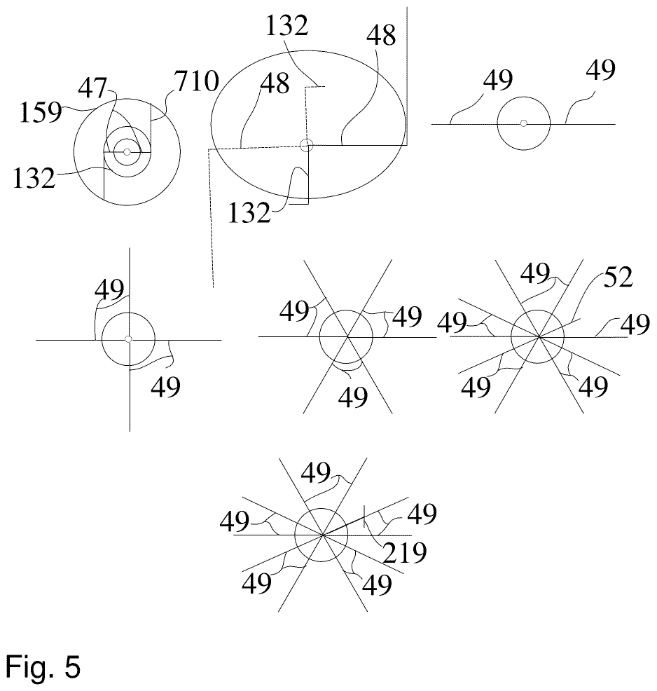

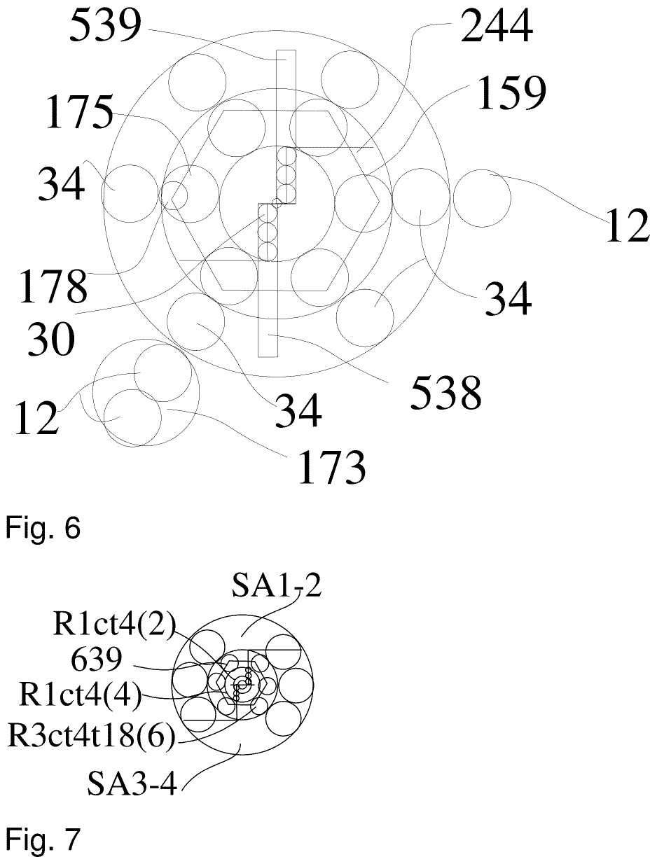

FIG. 5 illustrates a representative view of the growing proton count for protons based on fractal modeling, in accordance with an embodiment of the present disclosure. FIG. 6 illustrates a representative view of carbon based on fractal modeling, in accordance with various embodiments of the present disclosure. For the sake of brevity, FIGS. 5 and 6 have been explained together.

In an embodiment, FIG. 5 illustrates proton charting with balance derived from fpix and balanced solutions. The applicable fpix solutions include 1, −3, 5, −7, 9, −11. Each of the two inner arms holds a value of 1, followed by a negative value of −3 for the next arm, and the pattern continues. The fractal origin of proton and electron counts is graphically represented based on the equation 2f(x), where f(x)=fpix. This reflects the balancing factor of 2, critical to the defined structures, producing values such as 2×1=2, 2×−3=−6, 2×5=10, and so on. Even results correspond to noble gases, while odd results correspond to semiconductors. Referring further to FIG. 5, the figure shows two balancing hydrogens 70 for a helium atom 132, identified by the effective radius of the proton core. Additionally, it displays the 3-length negative value arms, two of which, when filled, correspond to carbon, identified by the potential carbon core radius 159. The figure progresses to Neon 48 with 5-unit balancing arms. For Argon, the scale changes, and while the −7 arms are not shown, their sum corresponds to Silicon. For Argon there are two balanced arms 49 giving the 18-proton total observed. After Argon, there are 4 9-unit arms 49 for Krypton, 6-9-unit arms 49 for Xenon and for Radon, there are 9, 9-unit arms plus a broken arm which is 5-unit unbalanced arm 52. Argon's balanced arms lead to the observed protons. Further, Krypton, Xenon, and Radon are represented with progressively increasing unit arms, with Radon featuring 9-unit arms plus a 5-unit unbalanced arm. Uranium is depicted with 10 9-unit arms, and a helium proton pair 219 appears where an unbalanced arm would have ended. This modeling's relevance is further explored in later sections.

Another embodiment considers FIG. 6, which demonstrates how atomic structure exposes outer electron-proton pairs. These pairs extend electron-positron bonds along fractal lines, providing stabilizing fulcrums with positrons on either side of the paired protons, facilitating the circulation of CT states and ensuring balance. The figure illustrates a copy engine (eng1R) 539 and a bottom engine (eng1L) 538, each containing three neutrons 30. The spirals that define the locations of the neutrons, resembling carbon equivalents, are depicted without numbering for clarity, as covered in prior patents. Outside the neutron-defining circle is a second circle that delineates the six-sided cube structure 244 of the balancing protons 175. Each proton 175 contains an unbalanced T15 state 178, allowing information sharing with a positron 34, balanced with either an electron 12 or an electron pair represented by a T13 state 173. This embodiment further explains how eight six-sided structures 244 surrounding a common neutron fulcrum 644 form a total of 48 neutrons, characteristic of the neutron core of Krypton's primary isotope. The spiral model defining the neutron core shows a transition from linear to curved spirals, rooted in the six-sided fractal form.

Analyzing Xenon with 77 neutrons, the embodiment addresses the backbone model using overlapping spirals, yielding a balanced 14 six-sided structures based on the fractal value of 5.5 for carbon. This balance aligns with the observed eight structures for Krypton and adds six more. The fractal math controls and yields repeatable results, overriding visual manifestations. Radon, with a neutron count of 135, is treated as a special case. Fractal math suggests a balanced 22-six-unit neutron state, even when accounting for an additional four neutrons trapped in the neutron backbone. This structure, despite Radon's instability and tendency to yield radioactive isotopes, aligns with the balanced nature of the noble gases under fractal modeling. This embodiment highlights that folding around a core traps information, with overlapping and information sharing, as seen in paired electrons along fractal spiral overlays, explaining bonding mechanisms. Energy is equated to pretime change, with folding and unfolding effects maximized to enhance energy storage, generation, and other matrix-related effects. As with iron exposed to ct4t11 shaping fields, atom layouts can be mechanically shaped and aligned to maintain desired effects. Targeting specific protons and electrons with KFE can maximize these effects, particularly for those exposed at the atom ends, with energy tending to flow out or cause atom breakdown in cases like radioactive decay when the neutron core is sufficiently imbalanced.

In an embodiment, FIG. 5 demonstrates the derivation of proton counts and electron orbitals using the equation 2f(n), where f(n)=fpix. The force is derived through a folding process according to the equation C(x)=2f(n)\hat{ }2n, which also facilitates the verification of the transition from fpix to MI. In this context, plasma is described as a solution of photons dissolving the a-positron to electron information sharing, and the fractal bonding of CO₂ is represented as a shared ct4t12 electron area. In an embodiment, the Basel problem and its solution are reimagined using fpix. The Euler Basel solution Σ (1 to ∞)1/(n\hat{ }2)=π/6 can be linked to fpix values. While traditionally the solution extends to infinity, under FIP, π is defined through a finite series based on 2f(n)\hat{ }2n. The negative values of fpix accelerate the convergence to π, yet they are not exponentially faster. The relationship between the sum of 1/n\hat{ }2 and π approaches 6, demonstrating the relationship between fpix and Basel solutions. In an embodiment, the Basel problem solution, adapted to fpix, shows that the ratio of the square root of the Basel sum to the sum of π\hat{ }2 approaches the square root of six (approximately 2.4495). This relationship underscores the role of fpix in calculating pi and its applications in geometric transitions, such as from two-dimensional to three-dimensional spaces. The inflection point π (4/6\hat{ }(−1/2)) is identified as a critical juncture in dimensional change, with implications for computational design and other applications.

In an embodiment, beyond the Basel problem, fpix and its inverse relationships provide insights into dimensional changes, particularly at the transition from fpix to MI during neutron bonding. This transition reflects shifts in geometry, where π(x)\hat{ }2 compared to other π values indicates these geometric transformations. The equation 6Σ (1 to ∞)1/n\hat{ }2=(1 to ∞) [4/fpix(n)\hat{ }2]/6 highlights the equivalence between these sums, providing a basis for understanding geometric and dimensional shifts. In an embodiment, the role of fpix extends to its connection with the golden ratio (Φ), represented as Φ=1−2 cos(3π/5). This formula reveals the transition between pi and MI, demonstrating a collapse of information from two-dimensional to three-dimensional space at specific transition points. The golden ratio, linked to fpix, further illustrates these transitions in geometry and dimensionality. In an embodiment, dimensional changes are further analyzed through the transition from square to circular geometries using fpix. The area of a circle (πr\hat{ }2) is redefined using fpix as 4r\hat{ }2/fpix, linking it to square geometry. This approach provides a framework for understanding dimensional transitions and geometric relationships, which are essential for modeling transitions in fusion, matter-to-energy conversions, and other physical processes.

In an embodiment, the volume and area of spheres and cubes follow the rules set by fpix, with specific ratios such as 16/3fpix for spheres and 2/3fpix for cubes. These ratios demonstrate the fractal nature of dimensional transitions, offering a model for understanding the differences between three-dimensional and higher-dimensional changes. In an embodiment, the intersection of fpix with the Basel problem shows that π can be calculated using fpix in finite terms, eliminating the need for infinite summation. The ratio π(x)\hat{ }2/(x−n)\hat{ }2 further explains the geometric transitions observed in physical phenomena, providing a mathematical basis for modeling these transformations. In an embodiment, the relationship between fpix, MI, and the golden ratio highlights the interplay of different geometric and numerical transitions. These relationships are essential for understanding how dimensions and curvatures evolve in complex systems, influencing applications such as quantum computing, energy transitions, and the design of geometric structures. In an embodiment, the modeling of transitions from three-dimensional to higher dimensions can be derived using fpix, offering insights into the nature of dimensional changes. These transitions are essential for understanding physical processes, where geometric changes impact energy and matter interactions, as demonstrated by the equations linking fpix to various dimensions and their corresponding geometries.

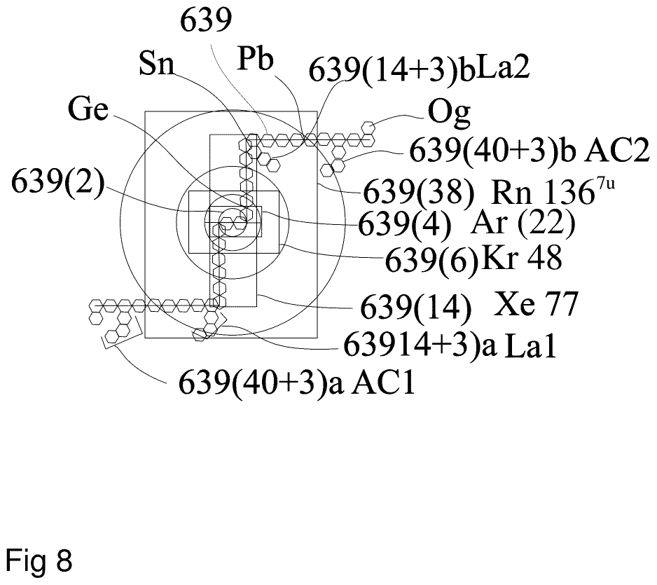

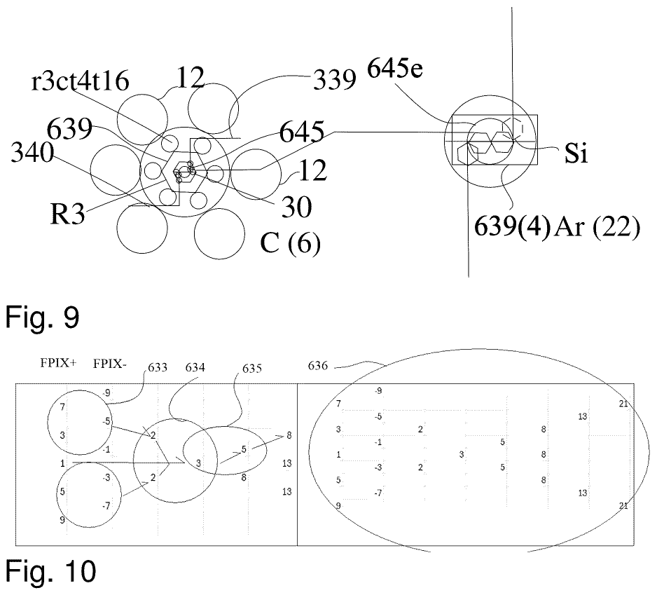

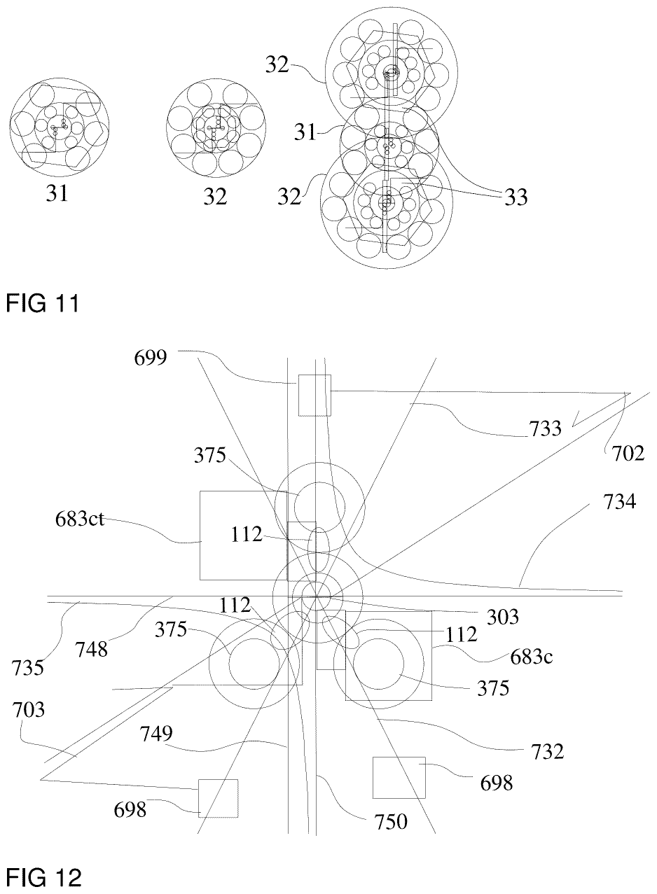

FIG. 7 illustrates a representative view of a larger atom neutron count based on fractal modeling, in accordance with various embodiments of the present disclosure. FIG. 8 illustrates a representative view of neutron bonding as sets of carbon-like base structures, in accordance with various embodiments of the present disclosure. FIG. 9 illustrates the carbon and argon neutron features giving rise to the structures, in accordance with various embodiments of the present disclosure. FIG. 10 illustrates an example of the fpix to MI transition, in accordance with various embodiments of the present disclosure as a way to view the MI series as coming off in another dimension from fpix compression modeling. FIG. 11 illustrates bonding represented from fractal modeling of atoms, in accordance with an embodiment of the present disclosure.

In an embodiment, a fractal algorithm-based universe must have base equations that are ubiquitous. For clarity, we begin with fpix, the equation giving rise to the denominator of pi, the ubiquitous phenomenon incorporating the equation is curvature. The process of using KFE to interpret and control interactions with a universe driven by pretime change can be identified without all of the refinements which will come about. Pretime refers to the dimensional changes that occur which give rise to time as stop-frame animation. At the levels where we live, there are at least three choices, Fibonacci (1,2,3,5,8,13), fpix (1,3,5,7,9), and the building sum (1,2,5,8,3,2,7,12) which results from the absolute value of “fused” values of fpix over time as shown in FIG. 1. An analysis of observations shows that all of these solutions to f(x) in the iterated equation CTx=f(x)\hat{ }2\hat{ }x evolve and devolve.

$$f\_pi ( x ) = \text{?} - 1 \text{?} {}^{⋀} x + 2 x * \text{?} - 1 \text{?} {}^{⋀} ( x - 1 )$$

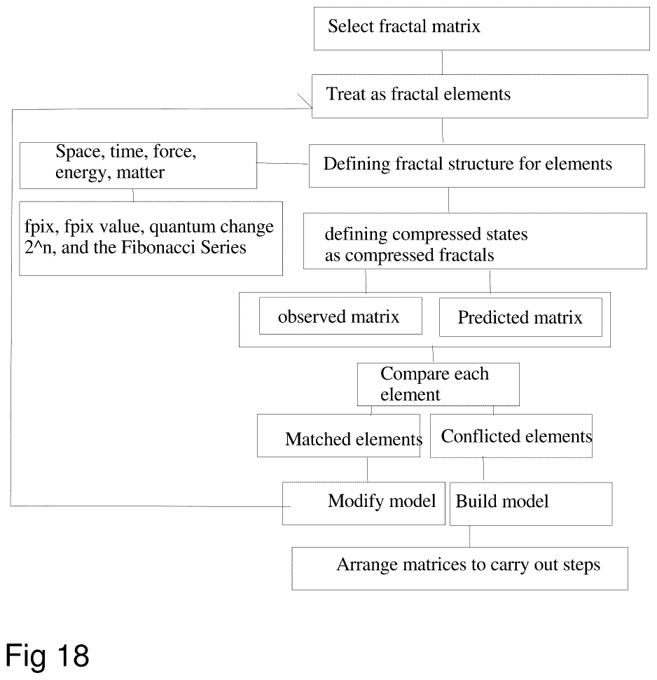

In an embodiment, the best mode corresponds to fractal AI, the AI is unable to work efficiently with scientific data. Further, the current scientific landscape suffers from inconsistent data terminology, different languages, and fragmented data structures across disciplines (physics, chemistry, biology, engineering, and to some extent within those disciplines) hindering knowledge extraction and analysis. In an embodiment, FIP provides for substituting different languages with a single underlying mathematics. A simplified outline of the process is shown in FIG. 18, fractal math is the application of iterated equations, foundationally the universe arises from iterated equations. Further, two clear examples of iterated equations seen ubiquitously are (1) the equation fpix, developed to generate the denominator of pi, and (2) MI (Fibonacci) which is seen in the golden ratio which appears at levels above the neutron. Applying mathematics in place of less specific modeling simplifies information storage and analysis. Because fpix can be represented as a bit (moving between positive and negative solutions) it is an efficient foundation since bits are the language used by computers to process information. In an embodiment, fractal modeling is used to simplify the data by breaking the science from articles into individual terms and then converting those to fractal mathematics. Further, errors and consistencies are detected by comparing the fractal math pathways to the interpretations in the absence of fractal math. This allows for simplifying and validating scientific data by converting as much of the word salad making up scientific articles into mathematics “based on common iterated equations” so they can be defined as different fractal representations of a common mathematics whether force, energy, or matter based. Fractal modeling reduces the number of variables by converting disparate data types (e.g. matter and energy) into features of a common fractal system, simplifying complex datasets. Resulting in non-fractal anomalies stand out, highlighting potential errors increasing clarity and confidence in their interpretations, and reducing “hallucinations,” since anomalies become evident. The process is applying a consistent mathematical framework across any or all scientific disciplines by focusing on permutations of fpix underpinning all dimensional features of the universe.

In an embodiment, fractal-based prioritization and averaging including repeated fractal features within complex datasets are used as signposts. These features guide the prioritization of relevant data, streamlining the analysis process. Irrelevant data is filtered out or processed at a lower priority speeding up the AI. Any averaging necessary to deal with the massive number of changes occurring in larger matrices would also be based on the underlying fractal framework. The AI applications can be used to filter out static/data blocking/other interference as non-fractal compliant, and it can be used to establish and break coding. For fusion this would be to take each fusion reactor, the setup of the fusion reactor, and convert everything to fractal modeling to test the fractal model against the results and how far they fall from fractal modeling. Non-fractal descriptors can be translated or eliminated from technical inquiries to make AI applications more efficient.

In an embodiment, the method includes the steps of using FIP algorithms to convert physics data to fractals and converting electrochemical and electronics data to fractals using fpix and evolutionary features of fpix. Further, the method includes the steps of using FIP algorithms that can convert the chemical data (from articles) to fractals. Furthermore, the method includes the steps of using the fractal origin of constants [gravity example, calculated results compared to observed results is used to gauge accuracy] so they can be used to evaluate the converted data. Also, the method includes the steps of using standard algorithms to pull out individual words or phrases which can be converted into fractal elements of chemical data can be seen as a step, and this is traditional in AI parsing of written and spoken words and the form of the information is only exemplary since this applies to information available in any form. In an embodiment, the method includes the steps of non-fractal, uncategorized information would be categorized as non-technical data, using algorithms to store data based on common FIP features of fractal data, using FIP algorithms to weigh and predict from the data through existing concepts in algorithms can be used to compare actual results, predicted results and those required by FIP modeling and weigh the data. Additionally, the method includes the steps of using programming to incorporate the results into MI. Each element is to be identified, categorized, measured, and compared between articles.

In an embodiment, the process includes converting chemical data (from articles) to fractals, converting physics data to fractals; and separating and defining data, particularly force/energy type data, based on dimensional transitions. Further, the process includes converting electrochemical and electronics data to fractals and converting uncategorized information to fractals (i.e. base iterated equations that can interface). Furthermore, the process includes defining the fractal origin of constants (gravity example, calculated results compared to observed results to gauge accuracy), defining the Relationships of data based on fpix, MI, and transitions in compression levels of these data, particularly where they can be based on resonance and 2f(n)\hat{ }2(n), storing data based on common fractal data, and compare predicted results to those set out in the data in question to weigh the data. In an embodiment, the resulting fractal components and the matrix defined by the content of the article can be rated according to the consistency of the article with the model and converted elements into fractal components. Further, the process will include modifications in sampling, conversion, and the underlying modeling used for conversion, storage, and models for analyzing and grading the converted data. Based on the feedback, the AI system updates its training data, model parameters, and algorithms (Model adjustment via Continuous Learning). In an embodiment, quantum change means that interactions between matrices are not functions of a complex set (energy, magnetism, force, etc.) over an undescribed concept of time, but instead mathematical transitions from positive to negative values over quantum changes defined by n=n+1. While this does not change the importance of time-based analysis, it allows for categorization based on quantum changes leading to time.

In an embodiment, interactions are viewed as pretime (energy/force) and post-time (denser information states, electrons, and larger and also pre-time elements that are not changing over time). The model should allow each element to be identified, categorized, measured, and compared between data in the form of articles on the science in question up to a point, where some approximation is necessary. Further, automation is based on the existing fractal framework compared to known outcomes with the modeling refined to improve the results, in short, a feedback loop. An AI feedback loop is an iterative process where an AI model's decisions and outputs are continuously collected and used to enhance or retrain the same model, resulting in continuous learning, development, and model improvement. In practice, there are at least two types of AI feedback loops: positive: users, in this case, LLMs, provide positive feedback when the model generates accurate outcomes aligned with their expectations. Negative: Users report flaws when the model produces inaccurate results, leading to system improvements. In an embodiment, more efficient storage and prediction using this modified data using existing LLM models is possible by reducing the parameters. This includes the ability to automate breaking data into fractal components. The ability to weigh the articles and the ability to weigh the fractal model to grade and/or improve different aspects is a separate criterion. The ability to provide common reference points for associating, comparing, and/or storing data based on fractal components. Duplicate information can also be limited.

In an embodiment, data storage and sorting with fractal features includes the process is using this base fractal architecture to define or design the coordinates for any purpose. Further, by creating a subset of fractal dimensions that are used in conjunction with the coordinates of the larger informational framework, similarities (and inaccuracies) can be identified. Searches can target one state, one particular category of fractal transition or compression as well as transitions and collections. Furthermore, currently, there are at least 15,000 dimensions for categorizing and cross-referencing locations of information in some AI applications. Categories in terms of fractal relationships may be reduced since a smaller number of features can be used to associate information in technical applications. Also, similarity searches can be based on an approximation locator based on common fractal elements, such as neutron-related features being tied to different levels of neutron compression. The process is defining AI data based on coordinates based primarily/even solely on fractal qualities, this can include using fractal modeling to define the sliding window to embrace information on either side of “rag memory” related to the area of association. In an embodiment, fractal features can help define the features of the sliding window based on common fractal features as well as proximate location. Further, results can be Graded based on expectations versus the actual results and then the process can be marked with the grade which grades can be assessed for patterns to improve the process. Furthermore, retriever and large language models (LLM) get data from vector embedding; associations connecting coordinates separated by distances defined by dimensions. Also, fractal modeling provides a homogenization-directed parameter that can be used to reduce the complexity of scientific data, a parameter that is clear as to “how they work, when they fail, and what they are even capable of due to their emergent properties.”

In an exemplary embodiment, the periodic table of the elements can have elements defined by a system of balanced fractals beginning with the proton and electrons as dual fpix spirals (2*1(He), −3 (C), 5 (Ne), −7(Si), 9(Ar)). In fractal terms, pi can be defined by the iterated equation: pi=sum (n=1 to infinity)4/fpix(x) where fpix=−1\hat{ }x+2x*[−1\hat{ }(x−1)]. N does not go to infinity, but since it is a very high number at the level where we exist, infinity is a useful estimate. This can be described using neutrons as dual MI (Fibonacci) modeling as shown in the discussion of FIG. 8. In fractal terms: MI(n)=(mi(n−1)+mi(n−2) where MI (1)=0 and MI (2)=1. Reconciliation of lower-level proton and neutron counts can also be seen as a function of a ratio of one fractal in a series to the next (1:2, 2:3, 3:5 for example) supporting the fractal relationship between stepped compression states. This defines a dimensional transition from a curvature-based model (more specifically a fpix model and a MI (Fibonacci series) model, at the neutron. Two times MI does not give the neutron count, but if you overlap 2 MI spirals with 2\hat{ }n diameter circles and match the inner diameter circle to the ⅔ overlap you get these lengths: 2 (He), 5.5(C), 9.8(Ne), 14.1(Si), 22.8(Ar) for the lengths of the spirals within the successively larger resulting circles. By their nature iterated equations provide a framework to nest increasingly compressed forms of information defined as ct1 states which are solutions to the equation fpix. Space is a dimensional effect. If you track evolving solutions to fpix with a common quantum change result folds from a one-dimensional linear set of solutions to a partially folded two-dimensional graph. This does not mean that the model is completely worked out, it just provides a foundation for understanding why this can work based on observed findings. Existing Components of the fractal model include: 1) Fpix, ubiquitously observed in curvature, 2) MI, observed above the level of the neutron and compression of fpix and MI based on 2f(n)\hat{ }(2\hat{ }n) where f(n) for electrons and protons is a function of fpix and a function of MI for neutron counts. For f(x)=fpix, where n=4, f(n)=7 and 2\hat{ }n=16. This allows the equation of 2f(n)\hat{ }16 to be viewed as 2 sets of 7 units doubling 16 times.

In another exemplary embodiment shown in FIG. 7, Carbon (12) is defined fractally as C1, R1ct4(2), R2ct4(4), R3ct4t17(6), R4ct4t13(6), SA1-2 and SA3-4, the longer numbering reflecting how they could be categorized for AI and ML applications. This defines carbon 12 as having 6 neutrons, 2 inner neutron backbone, 4 in the second backbone layer, 6 protons, 6 electrons, and 4 shared areas for bonding. Each of these elements is based on either MI (in the case of the neutron backbone) or fpix (all other parameters) along with the 2\hat{ }n portion of compression equation 2f(n)\hat{ }(2\hat{ }n). Atoms do not look like the resulting drawings. Galactic equivalents show the collapsed core to be small compared to the larger area “occupied” but the exponentially smaller lower ct states (electrons, photons, pre-photons, the components of space, but fractal equivalents allow for representations showing the relative effective size. Fractal relationships are dimensional features arising from the iterated equations. The “force” associated with bonds corresponds to sharing areas in the drawings which is a function of pi (fpix) and 2\hat{ } compression of information, not the size of the components.

In an embodiment, FIG. 11 shows Carbon 31, Oxygen 32, and CO2 as a combination of items 31 and items 32 using fractal modeling. Areas 33 shows where information is lost when the atoms overlap releasing information in the form of heat and light. A fractal description for carbon can be expressed as: C1, R1ct4(2), R2ct4(4), R3ct4t17(6), R4ct4t13(6), SA1-4. This defines the neutron as being in radius 1(R1) and radius 2 (r2); the protons as being in Radius 3 (r3) as the 17th transitional state leading up to the neutron, and the electrons as being in radius and being the 13th transitional state with room for up to 4 shared areas (SA1-4) in R (radius) for bonding with Oxygen which would have a similar designation. The two “shared” areas defined by the proton area are where information overlaps, fractal representations of dynamic bonding, and the “areas” are force equivalents. Since the information content remains the same the information lost when SA areas are filled is where heat from a reaction comes from allowing energy transitions to be modeled based on pretime change in information that is lost or gained. While this C1 designation for carbon appears more complicated, it allows the primary isotope of carbon to be described with only 2-dimensional features, ct state (compression state) and radius (R)level. This serves as a starting point for fractal modeling in AI applications for the first two lines of the PTE.

In an embodiment, the two areas where information overlaps are fractal representations of a more dynamic process, and the “areas” are fractal equivalents of spacing that are not restricted to the locations shown. Since the information content remains the same this “missing area” is where heat from a reaction comes from allowing energy transitions to be modeled fractally based on information that is lost or gained in combining atoms. For the elements in question, those within R1 and R2 have MI-based geometries, and those in R3 and R4 have fpix (curvature-based) geometries. Based on Mass consideration, the electron may be viewed as a ct4t13 and the proton as a ct4t16, understanding that there is a dimensional transition between the proton and neutron which accounts for the difference in appearance and mass.

A dimensional transition is reflected by the overlap of the information at the galactic center. Viewed from the next lower dimension, this is the “black hole core” of the galaxy. This is what happens when protons transition to neutrons at an exponentially lower scale.

In an embodiment, proton counts and electron orbitals are functions of 2 times fpix, namely 1, −3, 5, and −7. Two times the negatives (−3, −7) give rise to the semi-conductors up to Si), and 2 times the positive values (1,5) give the noble gases through Ar. We see nuclear forces based on 2\hat{ }n in 711b in FIG. 1 and this is reflected, in fractal terms in decompression photographed above right in an exploding galaxy (also seen in an exploding neutron star).

In FIG. 9 Carbon (6) is shown next to Argon (22) with carbon geometry-based neutron units 5.5 units 639 shown in FIG. 7 in carbon. Using FIP, a spiral galaxy can be compared to an atom. The FIP modeling of carbon in FIG. 8 shows item 639, shaped as a hexagon reflecting observed 6-sided effects for equally spaced the protons r3ct4t16 given the fractal representation for AI/ML of r3ct4t14(6) to reflect their compression state (ct4t14), their number (6) and their location (R3). The circles and hexagons are 2\hat{ }n circles based on the ⅔ overlap 645 of spiral arm 340 spiral arm 339 and as the diameter of the first circle. The neutrons 30 are shown relative to the protons and electrons 12.

The fractally relevant expansion of item 645 is shown as 645e for the argon atom reflecting the exponential increase in size.

As shown in FIG. 8, at higher neutron counts, the neutron backbone of the atom is built on “neutron units” 639 averaging 5.5, giving rise to 11 and 12 base backbone pairs, ignoring isotopes. Transitional Argon falls in the middle ground, capable of being defined by a single-core MI spiral or a two-core MI*5.5 architecture. This is an “inflection point,” a critical element seen in FIP for identifying transitions, including fusion and fission. Boron/Potassium elements of the P-N doping layers on different columns. There is base 18 (2*9) present in the periodicity (18) of lines 4-7 of the periodic table of the elements. Because of exponential changes in compression, the periodicity of the protons is secondary to the neutrons. Up to Argon, the neutrons bond without pairing into sets of 6 and control the periodicity; past argon, the proton periodicity begins to exert itself as base 18 (2*9), and the next step “Backwards” is base 14 (2*−7). The Lanthanides and Actinides drop back to base 14 being free of the primary neutron backbone as spiral arms off of the primary spiral. Note that La and Ag themselves are part of the base architecture, leaving a 14 (2*7) unit proton architecture. Hydrogen in not a true atom as it has no neutron backbone.

Showing the numbering with the associated element for clarity, there are 2,4,6,14,14+3, 38 different sets of the units 639, designated (so as to reflect the number of units 639), circle 639(2) which is in the base circle area for 2\hat{ }n circles as a point of reference, Argon area 639(4), Krypton area 639(6), Xe area 639(14), and Radon area 639(38). The Lanthanide series are shown generally at 639(14+3a) and 639(14+3) b and the Actinides as 639(40+3) a and 639(40+3) b to reflect their nature of off spiral features.

Lead falls within the semi-conductor category (Column 14, Tetryls). We can sequentially step down and separate energy from radiation using existing models for transitioning energy, namely: semiconductor chips of layered Pb (Lead), Sn (Tin), Ge (Germanium), Si (Silicon), or C (carbon) doped with P-N type doping to separate positive and negative charge to create current. At the inflection point, at column 3 (½ the N base 6), the Lanthanoid (row 6) and the actinoid (row 7) series begin. This reflects the interplay between the neutron backbone and proton core, you have the neutron arms (5N to 3P ratios) coming off on either spiral N arm to provide the base P arms. At the inflection point, at column 3 (½ the N base 6), the Lanthanoid (row 6) and the actinoid (row 7) series begin. This reflects the interplay between the neutron backbone and proton core. The neutrons control the proton count in the first three lines, then it shifts to neutron/base protons, and this shifts where the neutron arms branch off at rows 6 and 7 of the PTE where the reduced neutron concentration allows the protons to revert to base 14 P arms.

The Fibonacci sequence is calculated as follows: N(x)=(n(x−1)+n(x−2) so it involves the addition of the two prior solutions. Fpix=−1\hat{ }x+(2x*−1\hat{ }(x−1)) and Pi (4)=sum(n=1toz)+4/fpix(x)+4/fpix(x+n) where z is defined by the extent of compression, typically estimated at infinity, but actually on the scale considerably less. What you find is that protons follow a base 18 (2*9) architecture and neutrons follow an MI architecture which reflects the change in dimensional structure at the neutron. Rows 6 and 7 of the PTE have a base 18 (2*9) and base 14 (2*−7) architecture, reflecting multiple base numbering features. Column 3 in rows 6 and 7 are broken into base elements in terms of proton counts. This type of breakdown is typical in fractals with multiple base numbering systems. The neutron count is based on overlapping MI spirals and 2\hat{ }n compression. The Fibonacci sequence is calculated as follows: N(x)=(n(x−1)+n(x−2) so it involves the addition of the two prior solutions. Fpix=−1\hat{ }x+(2x*−1\hat{ }(x−1)) and Pi (4)=sum(n=1toz)+4/fpix(x)+4/fpix(x+n) where z is defined by the extent of compression, typically estimated at infinity.

At higher neutron counts, the neutron backbone of the atom is built on “lengths averaging 5.5, giving rise to 11 and 12 base neutron counts, ignoring isotopes. Argon falls in the middle ground, capable of being defined by MI*1 (column 1) or MI*5.5 (column 2) architecture. This is an “inflection point,” a critical element seen in FIP for identifying transitions, including fusion and fission. At the inflection point, at column 3 (½ the N base 6), the Lanthanoid (row 6) and the actinoid (row 7) series begin. This reflects the interplay between the neutron backbone and proton core. The neutrons control the proton count in the first three lines, then it shifts to neutron/base protons, and this shifts where the neutron arms branch off at rows 6 and 7 of the periodic table where the reduced neutron concentration allows the protons to revert to base P arms. Following the base pattern, these arms on either side of rows 6 and 7 track the structure of the electron/positron interface providing a balanced structure about the same base architecture (at 3, there is room for another 3 to form a 6) and it is seen that these structural features match the same structures seen at galactic levels. The transitions from quantum changes smooth out rigid structures from the distinct overlapping MI spirals to the graceful curves of the spiral galaxies and atoms. Since lead has a semiconductor fractal structure along with dense neutron-rich arms, it is excellent shielding. This represents the semi-conductor (SC) concept in terms of scale and geometry in a basic conversion system designed around 1) known SC design shown in concept, 2) known Periodicity (reflected in the PTE), and 3) fractal modeling. The location of the P-N interface and the layering (for example having silicone SC(s) within the lead, tin, or lead/tin/Ga interface)).

If you were to look deeply, it might appear that the neutron counts appear off for Lead and Tin, the math is similar for Germanium in terms of the number of sets of 6: 5.333Ge vs 11.333Sn vs 20.8333 for lead. For the base elements, these would be less compressed and outside of the orbit of the main atomic structure as a result, also expanded relative to those contraindicated by the mathematical nature of compression. Using the 5/3 rule (the approximate ratio between fpix and MI), that means there are between 11 and 12 neutrons to match each group of 7 (two of these) protons. Since the neutrons are still operating approximately on the 5.5 carbon model, there are two of these on each side counting down 3 units of 6 from the main arm and then another 3 units of 6 (18) on the other, 3 units of 6, really closer to 15 (5/3*9), on each of the main spiral arms.

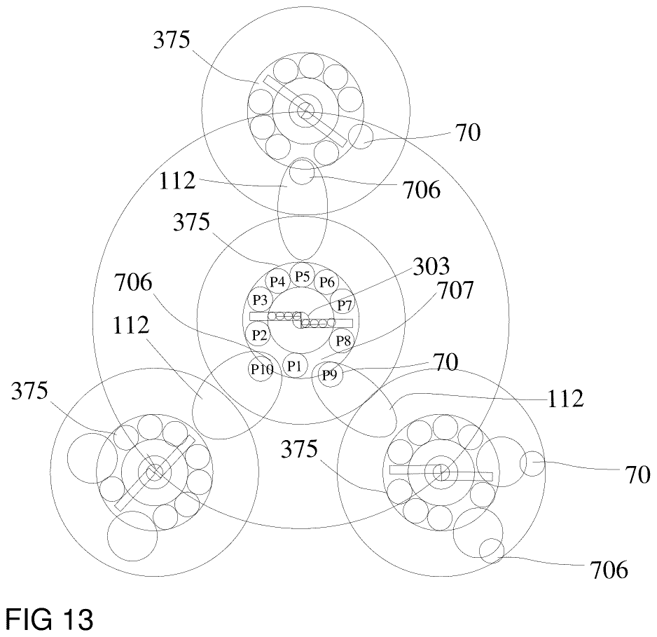

FIG. 12 shows how fractal modeling can be applied to hydrogen separation (or in reverse hydrogen ignition) from oxygen. Fractal modeling suggests that this is done by effectively dissolving the electron orbits 112. The “shape” of a fractal water molecule is overlaid as shown by the parts as numbered in and described in FIG. 13.

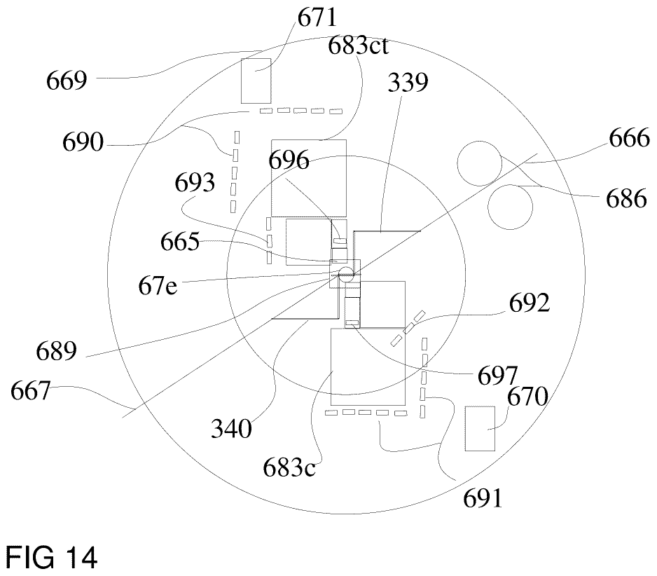

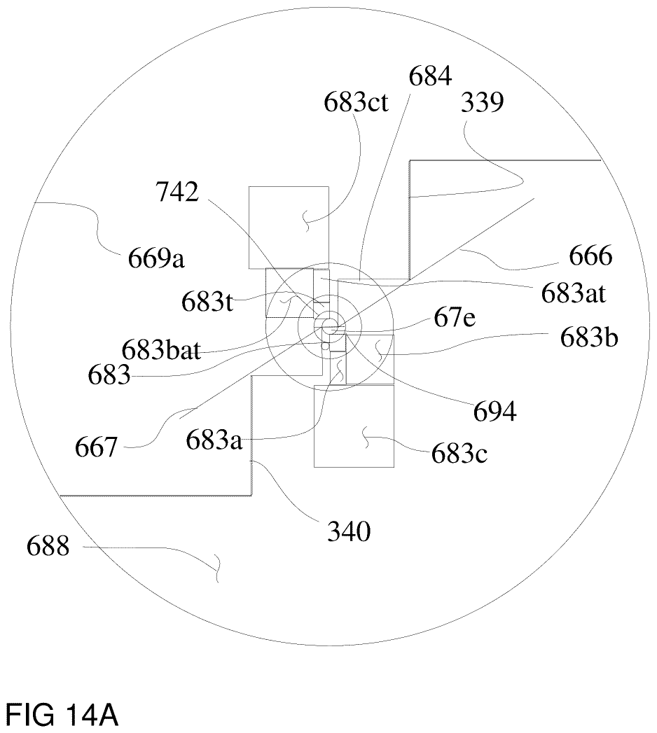

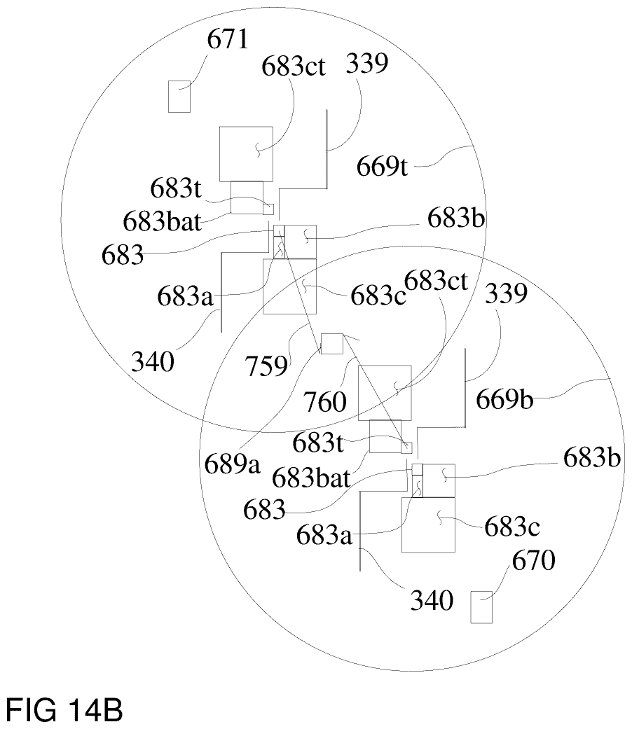

Positive electrode 698 (cathode) and negative electrode 699 (anode) can be positioned at KFE locations identified from FIGS. 14 and 19 in this case, for purposes of this example electrodes 698 are positioned at the same distance from the center of items 732 and 733 where the anode 799 is positioned opposite the overlaid water atom representation at item 750 allowing the different features of water molecules to be targeted according to their equivalent (although much smaller) locations. Extensions 702 and 703 can be used to realign the water or to target the offset neutron structure of the water.

Items 683c and 683ct show alternate locations to position reaction locations to take advantage of the fractal structural position of features of atoms.

Exponential spacing (designed about 2\hat{ }), fpix spacing, or MI spacing of multiple anodes and electrodes can be used to find the optimum relationship for different types of electrolysis.

In an embodiment, the present disclosure utilizes exponential, fpix, or MI spacing of multiple anodes and electrodes to establish optimal relationships for different types of electrolysis. Targeting hydrogen-to-hydrogen bonds involves fpix modeling, while targeting oxygen-to-hydrogen and oxygen-to-oxygen bonds requires a combination of fpix and MI modeling, with the latter requiring a higher proportion of MI. The shaping of electrodes, such as round to match 2n or hexagonal to match fpix or MI transitions, can be employed to improve the separation process. Multiple disconnection points can be designed to address hydrogen bonds shared remotely between oxygen and more directly with oxygen. This approach is effective at the catalyst surface. The separation process can be initiated by introducing one or more types of information, followed by a change to a second frequency or concentration of information. Additionally, inserting an information state within the matrix and exciting those inserted states can further enhance the separation efficiency.

In an embodiment, fractal modeling, a mathematical technique, is used to describe complex systems' structures and identify bonds most susceptible to disruption in hydrogen separation. This information guides the design of a process targeting these bonds to produce high-purity hydrogen. CT state targeting strengthens or weakens specific bonds between atoms using electric or magnetic fields. O—O sharing and H—H sharing are chemical bonds that can be leveraged to produce high-purity hydrogen by applying the appropriate conditions identified through fractal modeling. The use of fractal features in electrode design increases the efficiency of hydrogen separation by creating electrodes with high surface area to volume ratios, facilitating efficient contact between electrodes and water molecules. Employing diverse types of information, such as light frequency matching the resonant frequency of hydrogen bonds, enhances bond disruption and separation efficiency. Furthermore, inserting an information state within the matrix using a laser to create a specific energy state aids in the separation process. Incorporating Key Fractal Elements (KFE) into hydrogen separation techniques, whether in membranes, steam reforming steps, or catalysts, reduces the energy required for high-purity hydrogen production. Fractal modeling focuses on CT state sharing and disruption, efficiently separating hydrogen bonds and proton sharing, and manipulating electrode layouts and fractal features to optimize separation from water.

In an embodiment, quantum computing can also benefit from fractal modeling. By comparing quantum processors' probability modeling with fractal quantum change, pretime computing can correct probabilistic errors, improving accuracy. Quantum computers mimic pretime computing using approximations of pretime locations. Fractal modeling offers a framework to assess quantum processors' utility, correcting errors through pretime analysis. Fractal features and KFE can manipulate qubits by refining quantum computing processes through fractal algorithms, correcting quantum errors using known fractal results. These methods enhance the accuracy and efficiency of quantum computations by focusing on pretime locations rather than random approximations. Time dilation is another phenomenon explained through pretime change, where the ratio of pre-ct4t13 states within a ct4-ct5 transitional state to those outside it creates a time dilation ratio. Acceleration slows time and increases length, as observed in pretime change compared to post-time change. Gravity, seen as a net increase in folding, affects the visibility of changes from the standpoint of time, with compressed matrices exhibiting slower time due to fewer pretime changes. These embodiments showcase the application of fractal modeling and KFE across various scientific and technological domains, enhancing efficiency and accuracy in processes like hydrogen separation, quantum computing, and understanding time dilation.

FIG. 13 illustrates a representative view of water using fractal modeling, in accordance with an embodiment of the present disclosure. What this shows is that water has a neutron backbone 303 with 8 protons numbered for the center Oxygen as P1-P8. Between P1 and P2 is backbone-electron information-sharing area 706. Between P1 and P8 is the second backbone-electron information sharing area 707 which gives water its unique shape. Above P1 and at P5 is electron-proton sharing between the oxygen-proton core 375 and a free hydrogen 70 which is weak since the extent of information sharing is limited between the proton 70 and the electron orbit 112 on either side with the area of the oxygen atoms designated as adjacent to the P5 proton of oxygen.

The bottom free hydrogen protons are designated as P9 and P10 because they can share information more directly with the neutron backbone through areas 706 and 707.

The expansion of water, for energy generation or in pistons or for propulsion can be viewed in terms of changing the bonds between the oxygen and the hydrogen at different energies interpreted as different amounts of pretime change, ct4t11 states, and the resulting changes in the electron orbitals 112.

Electron sharing is viewed in terms of overlap as well as shared ct4t12 states as well as their associated ct4t11 composite magnetic effects (M+ to distinguish them from e−, the electron).

Because the model is fractal, fractal patterns exist. The specifics allow CT state targeting to strengthen one bond hydrogen type over the other. The bonds and electron orbitals are defined by fractal connections and can be targeted as fractals in order to get efficient changes. This can reflect the changing fractal numbers reflecting bonds, the changing size, and ultimately the type and amount of CT states in the matrices. These fractal features change along fractal lines according to the fractal equations of AuT.

Fractal modeling removes the focus from charge to CT state sharing and the disruption of CT states to target separation of hydrogen bonds (remote) and proton sharing (close). This also means creating an environment conducive to O—O sharing and H—H sharing while also disrupting the alternative bonds as a single step or as sequential steps.

The location of where the charges are directed as shown can be based on the MI, fpix, and 2\hat{ }n separation to mimic/replace/disrupt the different bonds based on their separation, the information shared, the base numbering, and the other KFE.

H20 separation layouts are modeled with 0.75 of radius moves from outer to middle, and 1.25 of radius moves from inner to 1rs inside.

This shows AuT or normal tesla valves with the length and angles defined by lines or curves defined by fpix or mi spirals or the length being defined by the 2\hat{ }n exchange areas.

The layout of (left) anodes and cathodes and (right) a cathode broken out in the same fashion.

The process can be reversed at some level and with some timing to encourage H2 formation from the dissolved water.

The two features are exponential change, balance, 2f(n), especially based on fpix for the Hydrogens and bonds, but moderated by the MI for the Oxygen.

FIG. 14A shows FIG. 14 but with elements removed to prevent clutter and modeling from FIG. 14.

FIGS. 14 and 14a show that to get to Proton to Neutron fusion.

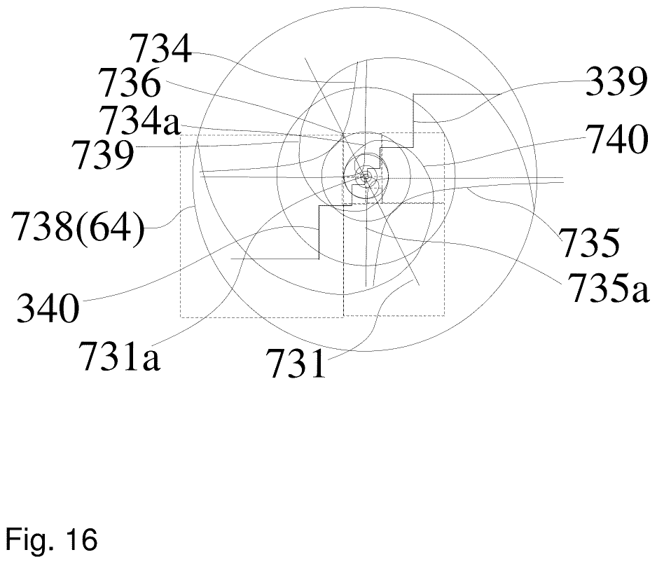

FIG. 14a and FIG. 19a reflect fpix, pre-neutron architecture. FIG. 14, 14a and FIG. 16 shows the shift to MI architecture and FIG. 10 shows the transitional nature of the transition resulting from the resonance and compression of fpix results.

In FIG. 14, it is possible to have the compression of information along these areas of resonance at different locations within a plasma containment vessel. It is possible to have the heavier layers, neutrons being the heaviest, pushed through the less heavy layers representative quantities required to properly shape the fulcrums mechanically, maybe even bouncing between outer and inner reaction chambers.

The reactor area 688 is a combination of 2\hat{ }n compression areas based on 2\hat{ }n for circles based on the overlap as shown in FIG. 14 by reaction chamber 669 and based on 2\hat{ }n circles based on the resonance shown in item 730a in FIG. 19 represented here by reaction chamber second dimension 669a which is 2\hat{ }5 (64) or 5 times the diameter of where item 730a would otherwise appear in FIG. 14.

One feature of the method is targeting the neutrons using MI spiral alignment for the neutrons and fpix alignment for the protons and electrons and alignment successively or by layer as shown in FIGS. 14, 14a and in an alternative embodiment in 14b.

The overlapping MI spiral framework is defined by the areas defined by top spiral arm 339 and bottom spiral arm 340 which serves as a template for the neutrons to be guided into the appropriate MI alignment within reaction chamber 669 (in FIG. 14b there is a top reaction chamber 669t and a bottom reaction chamber 669b). To bring the protons into position to stabilize neutrons present or formed during the reaction. In this case, item 683t from item 669b is brought through layers represented by items 683bat and 683ct from item 669b while item 683 from item 669t is brought the layers 683b and 683c of item 669t so that fusion can occur about item 689a.

There are martialing areas for the different ct states, here represented by neutron which can be collected in neutron area 683 and top neutron area 683t about the overlap of items 389 and 340; proton area 683b and top proton area 683bt and electrons in electron area 683c and top electron area 683ct. Modeling indicates another two reactant areas 683a and 683at arranged as shown and the exact mix of ct states is subject to experimentation.

A means to bring these items together and along the fractal arrangement shown is shown here as a top proton canon means 671 providing protons and a bottom proton canon means 670 for pushing the elements together in alignment with the fractal arrangement shown along two fulcrums comprised of top channel 666 offset from bottom channel 667 by the overlap 67e of the top spiral arm 339 and bottom spiral arm 340. In most cases a plasma generator 694 provides a means for providing separated protons, neutrons and electrons.

An area of dimensional shift means 742 which is 2\hat{ }n typically of the overlap 67e is a means for shifting between MI at the center for neutrons and fpix alignment for the aligning protons and electrons.

A proton accelerator means 689 for providing where the parts are received with the appropriate spacing and alignment as required by the fulcrums defined by KFE. Items 670 and 671 can be replaced with lasers or other means which can push the reacting element together. Since neutrons are hard to control themselves, reactant areas 683a and 683at may contain a neutron rich isotope from which items 683 and 683t receive neutrons during the process.

In FIG. 14b, item 689 is replaced with central proton accelerator means 689a which items 669t and 669b may circle allowing a taurus type arrangement so that one or more items 670 and 671 can drive the ct states together along top compression vector 759 and bottom compression vector 760 as they reach various alignment positions as they rotate.

To maintain the protons, neutrons and electrons in place, different means can be used, here exemplified by the interaction of outer magnet pair 686, electron holding field magnets 690, proton holding field magnets 693, neutron generating means 695 positioned around the point of overlap 67e with corresponding bottom electron holding field magnets 691 and bottom proton holding field magnets 692.

Top alignment means 696 and bottom alignment means 697 for maintaining the structure of the resulting atom as it is compressed from the large amounts of information in the plasma can facilitate the fusion of elements.

While the exterior field generator is shown offset, it might be centered, and the number and positioning would vary depending on how to isolate the CT states and generate the desired matrices.

Together these provide a means to force concentration of the ions of the reaction and keep them increasingly focused while not maintaining them in a form which discourages compression but instead removes the space between them in the form of lower pretime states in fractal alignment. The elements are used together at the concentration, force or dimensional level at successive concentrations for the different components of fusion (M+, electrons, protons, ct4t15 states, positrons, neutrons) at levels of 1,3,5,7 or 7,5,3,1 for fpix layouts to give pre-neutron alignment effects or levels of 1,2,3,5,8 or 8,5,3,2,1 sequences to give neutron level effects along with template means guiding the elements into their appropriate places.

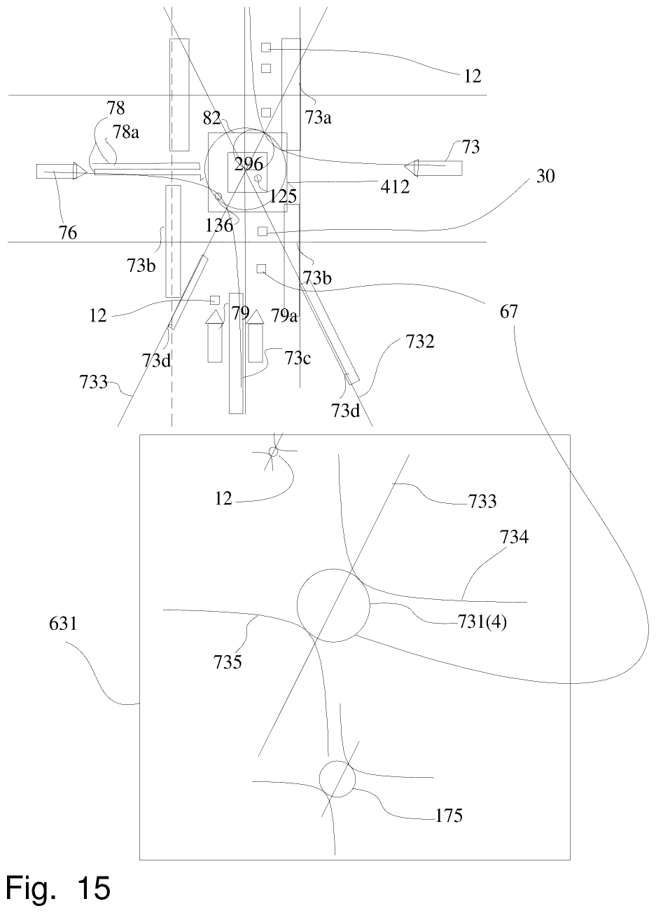

FIG. 15 shows alignment to collapse the Porton portions and electrons into neutrons. As shown in FIG. 15 and FIG. 2c, electron are perceived as aligned along of fulcrum of two arms or curves, represented by items 734 or the area between 734 and 734(2) some evidence that it could be 4 together as each electron is only half of a pair and hence the view of FIG. 19. The electron may be ct4t12 (abbreviated t12) or ct4t13 (abbreviated t13) to get size and weight right, best guess right now, evidence of stability along 2\hat{ } lines, so if the proton is 16 and therefore stable, electron would be ct4t12 and photon might be all the way down to ct4t8 or ct4t4 although that is not believed to be the case.

FIG. 15 includes closeup 631 showing the relative sizes of the proton 67 to the electron 12 and an intermediary (non-resonant and therefore unstable) ct4t15 174. Items 174 would align along curves 734 and 735 in equal numbers and, assuming that number is 14 (base 14 fractal compression representing the 14 steps between ct3 and ct4), for the sake of this discussion there would be 7 on each arm so that the design is relatively specific. Since electron 12 is 4 steps below 16, there would be 7 ct4t14 states, and there would be 7 ct4t13 states along each curve corresponding to items 734 and 735 of the ct4t14 states giving more detail. It is important to remember that free states of information, largely viewed as space in pre-fractal mathematics would be included in this arrangement. A simpler view of this concept can be seen in the discussion of FIG. 2b.

To give an example of how Compression can be modeled using fractals, FIG. 15 shows alignment with the geometry from FIG. 19. Fpix plot reaction drivers 73d align with items 733 and 732 to focus compression along the line, typically items 73d would be lasers. Offset drivers 73b at what would be the y axis in FIG. 19 and the edge of the concentrator means 296 provide alignment of protons 67, neutrons 30 and electron driver ensures balancing electrons 12 are brought to bear in the order desired to get a balanced fusion result.

Reactants 78 and 78a may be added by first source driver 76 and reaction driver 73 to bring the elements together along the lines defined by items 734 and 735 shown in the expanded view 631

A concentrator means separation at the very center (296) as two balanced neutrons, then proton, and then electron layers are compressed about these separating lasers.

This gives a slightly different view of the electron shown in FIG. 2c, but only in terms of the specifics suggested for the geometry.

To get fusion you need to bring things together along the indicated lines which are a little different for “proton to neutron” fusion which is FIG. 19a plus FIG. 10.

Neutron-to-neutron fusion requires fpix balance features, but deals with the backbone which is a feature of MI geometry.

Not only are these steady compression steps necessary for fusion, but they can also be used to target where to take off force, energy being of particular interest, but negative gravity might be an extreme example, along fractal lines defined by dimensional shapes and transition along this process.

Looking at FIG. 19a, items 732 and 733 may be viewed as vectors along which to insert or take off information, energy for example.

The process is to define pathways defined by the materials themselves and their arrangement along the lines of the resulting design of information compression and the resulting structures so that you can take off energy along those multiple points or average points of transition. These transitions can be used in semiconductor and solar designs including the curved nature leading up to the points of inflection which are specific mathematically.

The various driver means can both insert and remove information sequentially and reinsert information where pulsing is required to mix compress or decompress the information mix defining the different forms of information within the reaction chamber. One type of information may be used to push another out, such as using energy to push neutrons together and remove pre-time information states between the neutrons, but also the ensure that shared information states between neutrons and stabilizing information states around combined neutrons are present.

It is important to look for examples of where, using KFE, Inflection points can be identified using mathematics and things tending towards compression, and things that tend in a way from compression can be determined by examination and these features can be targeted, used for interpretation, design, and implementation. For example, to build FIGS. 14 and 14a, the transitions (where the next larger MI-sized box) for items 683 and 683a-c (and beyond) where 683 is 1 bottom and 683t is 1 for the top:

| | | |
|---|---|---|
| 1 | bottom | for top |
| 2 | above | below |
| 3 | right | left |
| 5 | below | above |
| 8 | left | right |
| 13 | above | below |
| 21 | right | left |
| 34 | below | above |
| 55 | left | right |

Spin: There is a reason to consider that items 1 and 2 only are shifted in position. For that reason, starting compressive spins in one direction and then shifting to the other may be indicated. They are shown this way for consistency. Both spin and compression can occur after the initial alignment as set out in FIG. 14 and the chart immediately above for the bottom and top.

As will be understood, it may be helpful for ct1-ct3 states (not shown) to be drawn out of the reaction chamber through vacuum line means 136 which can be identified as a means for preferentially changing the mix of ct1, 2, and 3 and low compression ct3-4 transition states within the reaction chamber 82 sequentially or otherwise. These are not traditional vacuum lines since traditional vacuums do not exist in AuT, but that is the closest designation available and they may otherwise be thought of as ct1, ct2, and ct3 state removal systems.

Size: The arrangements are likely not possible at atomic sizes; the idea is to create a fractally equivalent layout so that when compressed the alignments and balancing are consistent with the smaller compression that must take place at the atomic level.

To remove helium or other contaminants (anything which is counter to the reaction) from the chamber there is at least one reactant recycling line means 125 can pull off reactants from the chamber 82 or at least outside of the concentrator means 296.

Neutrons 30 are delivered to the concentrator means 296. It is preferably rotationally balanced along fractal lines where this symmetry is reflective of the stability of balanced information between the more compressed protons and the less compressed electrons and is part of the reason black holes are believed to exist in spiral galaxies in minimums of pairs.

In this way, the momentum reflects the stability of lower compression states.

It is possible to target the Fibonacci form by going from one state to the other, e.g. swirling it to a smaller area according to this formula or a bigger one to enhance the potential to fuse the neutrons, to bring them together.

When the conceptual “specific fractal jumps” are viewed, it can be seen how specific “excitement energy states” of a hydrogen necessarily fit within the structures that are in place to create a fractal (compared to the larger fractal spiral galaxy) and staged (see the different stable states of each fractal understanding there are sub-fractals which are more pronounced as compression increases which can be seen by the t1-t16 CT4 transitional states and the very complex galactic models between ct4 and ct5 seen through telescopes) set of energy levels observed.

The focus in all transactions in this science includes identifying and controlling the places where information exchange occurs. It is difficult to directly affect CT states below ct11, but they can be indirectly determined and ordered in such a way as to improve information exchange and, ultimately, move up or down the chain of compression.

Every electric field includes magnetic components, the more dimensional circulation (as with transformers) the more you push out and accelerate the ct4t11 field. A transformer circuit is to create a series of ct4t11 “hurricanes” (ct4t11-H) which carry their pretime change to the other transformer which can be more efficiently placed at multiple locations around the stepped-up portion to capture the maximum number of these spun-off CT states.

Iron cores do more than traditional alignment enhancement of the “fields,” in this case targeting the iron (or Ni or other magnetic carrier) with providing a surface for the travel of these ct4t11-H in the direction where they are most easily transferred to the secondary coil if the primary coil is the one from which they are generated.

The fusion process may be described according to these steps: 1) separating out neutrons from their associated shells to the extent possible within a matrix of ct1-ct3 states; 2) utilizing the compression of ct states between ct1 and ct4 to crowd out lower ct states until the neutrons are sufficiently close to allow the sparing of spew between the neutrons and 3) utilizing ct3-4 transition states in order to provide a stable shell to allow for the absorption and spew of the neutrons to be maintained.

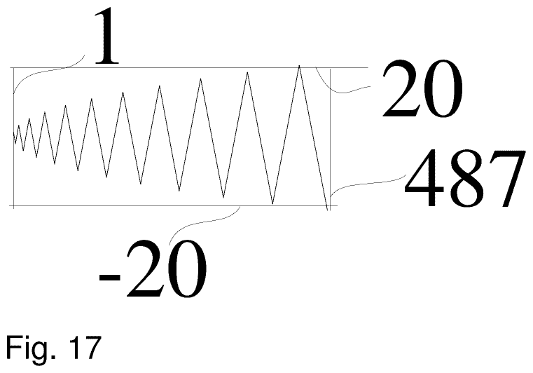

FIG. 17 illustrates a representative view of one form of ct1 solution folding, in accordance with various embodiments of the present disclosure.

FIG. 18 illustrates the process steps to carry out fractal modeling of existing science and to use that in further design, in accordance with various embodiments of the present disclosure.

FIG. 18 shows a simplified outline of the process.

Fractal math is the application of iterated equations. Foundationally the universe arises from iterated equations. Two clear examples of iterated equations seen ubiquitously are (1) the equation fpix, developed to generate the denominator of pi, and (2) MI (Fibonacci) which is seen in the golden ratio which appears at levels above the neutron. Applying mathematics in place of less specific modeling simplifies information storage and analysis. Because fpix can be represented as a bit (moving between positive and negative solutions) it is an efficient foundation since bits are the language used by computers to process information.

Simplification: Fractal modeling is used to simplify the data by breaking the science from articles into individual terms and then converting those to fractal mathematics.

Errors and consistencies are detected by comparing the fractal math pathways to the interpretations in the absence of fractal math. This allows for simplifying and validating scientific data by converting as much of the word salad making up scientific articles into mathematics “based on common iterated equations” so they can be defined as different fractal representations of a common mathematics whether force, energy, or matter based. Fractal modeling reduces the number of variables by converting disparate data types (e.g. matter and energy) into features of a common fractal system, simplifying complex datasets. Resulting in non-fractal anomalies stand out, highlighting potential errors increasing clarity and confidence in their interpretations, and reducing “hallucinations,” since anomalies become evident. The process is applying a consistent mathematical framework across any or all scientific disciplines by focusing on permutations of fpix underpinning all dimensional features of the universe.

### Fractal-Based Prioritization and Averaging

Repeated fractal features within complex datasets are used as signposts. These features guide the prioritization of relevant data, streamlining the analysis process. Irrelevant data is filtered out or processed at a lower priority speeding up the AI.

Any averaging necessary to deal with the massive number of changes occurring in larger matrices would also be based on the underlying fractal framework.

The AI applications can be used to filter out static/data blocking/other interference as non-fractal compliant, and it can be used to establish and break coding.

For fusion this would be to take each fusion reactor, the setup of the fusion reactor, and convert everything to fractal modeling to test the fractal model against the results and how far they fall from fractal modeling. Non-fractal descriptors can be translated or eliminated from technical inquiries to make the AI applications more efficient.

The method can be defined using the following steps:

Use FIP algorithms to convert physics data to fractals.

Convert electrochemical and electronics data to fractals using fpix and evolutionary features of fpix.

Use FIP algorithms that can convert the chemical data (from articles) to fractals.

Use the fractal origin of constants [gravity example, calculated results compared to observed results is used to gauge accuracy] so they can be used to evaluate the converted data;

Using standard algorithms to pull out individual words or phrases which can be converted into fractal elements of chemical data can be seen as a step, and this is traditional in AI parsing of written and spoken words and the form of the information is only exemplary since this applies to information available in any form;

Non-fractal, uncategorized information would be categorized as non-technical data;

Using algorithms to store data based on common FIP features of fractal data.

Using FIP algorithms to weigh and predict from the data.

Existing concepts in algorithms can be used to compare actual results, predicted results, and those required by FIP modeling and weigh the data.

Using programming to incorporate the results into MI. Each element is to be identified, categorized, measured, and compared between articles.

The following independent steps are relevant to the process:
a. convert chemical data (from articles) to fractals, convert physics data to fractals; separating and defining data, particularly force/energy type data, based on dimensional transitions,
b. convert electrochemical and electronics data to fractals,
c. convert uncategorized information to fractals (i.e. base iterated equations that can interface).
d. define the fractal origin of constants [gravity example, calculated results compared to observed results to gauge accuracy];
e. Define the Relationships of data based on fpix, MI, and transitions in compression levels of these data, particularly where they can be based on resonance and 2f(n)\hat{ }2(n).
f. Store data based on common fractal data.
g. Compare predicted results to those set out in the data in question to weigh the data.

The resulting fractal components and the matrix defined by the content of the article can be rated according to the consistency of the article with the model and converted elements into fractal components.

The process will include modifications in sampling, conversion, and the underlying modeling used for conversion, storage, and models for analyzing and grading the converted data. Based on the feedback, the AI system updates its training data, model parameters, and algorithms (Model adjustment via Continuous Learning).

Quantum change means that interactions between matrices are not functions of a complex set (energy, magnetism, force, etc.) over an undescribed concept of time, but instead mathematical transitions from positive to negative values over quantum changes defined by n=n+1. While this does not change the importance of time-based analysis, it allows for categorization based on quantum changes leading to time.

Interactions are viewed as pretime (energy/force) and post-time (denser information states, electrons, and larger and also pre-time elements that are not changing over time). The model should allow each element to be identified, categorized, measured, and compared between data in the form of articles on the science in question up to a point, where some approximation is necessary.

Automation is based on the existing fractal framework compared to known outcomes with the modeling refined to improve the results, in short, a feedback loop. An AI feedback loop is an iterative process where an AI model's decisions and outputs are continuously collected and used to enhance or retrain the same model, resulting in continuous learning, development, and model improvement. In practice, there are at least two types of AI feedback loops: Positive: Users, in this case, LLMs, provide positive feedback when the model generates accurate outcomes aligned with their expectations. Negative: Users report flaws when the model produces inaccurate results, leading to system improvements.

More efficient storage and prediction using this modified data using existing LLM models is possible by reducing the parameters. This includes the ability to automate breaking data into fractal components. The ability to weigh the articles and the ability to weigh the fractal model to grade and/or improve different aspects is a separate criterion. The ability to provide common reference points for associating, comparing, and/or storing data based on fractal components. Duplicate information can also be limited.

Data Storage and Sorting with Fractal Features

The process uses this base fractal architecture to define or design the coordinates for any purpose.

By creating a subset of fractal dimensions that are used in conjunction with the coordinates of the larger informational framework, similarities (and inaccuracies) can be identified. Searches can target one state, one particular category of fractal transition or compression as well as transitions and collections.

Currently, there are at least 15,000 dimensions for categorizing and cross-referencing locations of information in some AI applications. We can reduce categories in terms of fractal relationships since a fewer number of features can be used to associate information in technical applications.

Similarity Searches can be based on an approximation locator based on common fractal elements, such as neutron-related features being tied to different levels of neutron compression.

The process is defining AI data based on Coordinates based primarily/even solely on fractal qualities, this can include using fractal modeling to define the sliding window to embrace information on either side of “rag memory” related to the area of association. Fractal features can help define the features of the sliding window based on common fractal features as well as proximate location.

Results can be Graded based on expectations versus the actual results and then the process can be marked with the grade which grades can be assessed for patterns to improve the process.

Retriever and large language models (LLM) get data from vector embedding; associations connecting coordinates separated by distances defined by dimensions.

Fractal modeling provides a homogenization-directed parameter which can be used to reduce the complexity of scientific data, a parameter which is clear as to “how they work, when they fail, and what they are even capable of due to their emergent properties.”

Example 1: The periodic table of the elements can have elements defined by a system of balanced fractals beginning with the proton and electrons as dual fpix spirals (2*1(He), −3 (C), 5 (Ne), −7(Si), 9(Ar)). In fractal terms, pi can be defined by the iterated equation: pi=sum (n=1 to infinity)4/fpix(x) where fpix=−1\hat{ }x+2x*[−1\hat{ }(x−1)]. N does not go to infinity, but since it is a very high number at the level where we exist, infinity is a useful estimate. They can be described using neutrons as dual MI (Fibonacci) modeling as shown in the discussion of FIG. 8. In fractal terms: MI(n)=(mi(n−1)+mi(n−2) where MI (1)=0 and MI (2)=1. Reconciliation of lower-level proton and neutron counts can also be seen as a function of a ratio of one fractal in a series to the next (1:2, 2:3, 3:5 for example) supporting the fractal relationship between stepped compression states. This defines a dimensional transition from a curvature-based model (more specifically a fpix model and a MI (Fibonacci series) model, at the neutron. Two times MI does not give the neutron count, but if you overlap 2 MI spirals with 2\hat{ }n diameter circles and match the inner diameter circle to the ⅔ overlap you get these lengths: 2 (He), 5.5(C), 9.8(Ne), 14.1(Si), 22.8(Ar) for the lengths of the spirals within the successively larger resulting circles.

By their nature iterated equations provide a framework to nest increasingly compressed forms of information defined as ct1 states which are solutions to the equation fpix. Space is a dimensional effect. If you track evolving solutions to fpix with a common quantum change result folds from a one-dimensional linear set of solutions to a partially folded two-dimensional graph. This does not mean that the model is completely worked out, it just provides a foundation for understanding why this can work based on observed findings. Existing Components of the fractal model include: 1) Fpix, ubiquitously observed in curvature, 2) MI, observed above the level of the neutron and compression of fpix and MI based on 2f(n)\hat{ }(2\hat{ }n) where f(n) for electrons and protons is a function of fpix and a function of MI for neutron counts. For f(x)=fpix, where n=4, f(n)=7 and 2\hat{ }n=16. This allows the equation of 2f(n)\hat{ }16 to be viewed as 2 sets of 7 units doubling 16 times.

Example 2: Carbon (12) is defined fractally as C1, R1ct4(2), R2ct4(4), R3ct4t17(6), R4ct4t13(6), SA1-4. This defines carbon 12 as having 6 neutrons, 2 inner neutron backbone, 4 in the second backbone layer, 6 protons, 6 electrons, and 4 shared areas for bonding. Each of these elements is based on either MI (in the case of the neutron backbone) or fpix (all other parameters) along with the 2\hat{ }n portion of compression equation 2f(n)\hat{ }(2\hat{ }n).

Atoms do not look like the resulting drawings. Galactic equivalents show the collapsed core to be small compared to the larger area “occupied” but the exponentially smaller lower ct states (electrons, photons, pre-photons, the components of space, but fractal equivalents allow for representations showing the relative effective size. Fractal relationships are dimensional features arising from the iterated equations. The “force” associated with bonds corresponds to sharing areas in the drawings which is a function of pi (fpix) and 2\hat{ } compression of information, not the size of the components.

A fractal description for carbon can be expressed as: C1, R1ct4(2), R2ct4(4), R3ct4t17(6), R4ct4t13(6), SA1-4.

This defines the neutron as being in radius 1(R1) and radius 2 (r2); the protons as being in Radius 3 (r3) as the 17th transitional state leading up to the neutron, and the electrons as being in radius 4 and being the 13th transitional state with room for up to 4 shared areas (SA1-4) in R4 (radius 4) for bonding with Oxygen which would have a similar designation.

The two “shared” areas (33) defined by the proton area are where information overlaps, fractal representations of dynamic bonding, and the “areas (33)” are force equivalents. Since the information content remains the same the information lost when SA areas are filled is where heat from a reaction comes from allowing energy transitions to be modeled based on pretime change in information which is lost or gained.

While this C1 designation for carbon appears more complicated, it allows the primary isotope of carbon to be described with only 2-dimensional features, ct state (compression state) and radius (R)level. This serves as a starting point for fractal modeling in AI applications for the first two lines of the PTE.

The two areas (33) where information overlaps are fractal representations of a more dynamic process and the “areas” are fractal equivalents of spacing that are not restricted to the locations shown. Since the information content remains the same this “missing area” is where heat from a reaction comes from allowing energy transitions to be modeled fractally based on information which is lost or gained in combining atoms.

For the elements in question, those within R1 and R2 have MI-based geometries, and those in R3 and R4 have fpix (curvature-based) geometries.

Based on Mass consideration, the electron may be viewed as a ct4t13, based on resonance it might be ct4t12, and the proton as a ct4t16, understanding that there is a dimensional transition between the proton and neutron which accounts for the difference in appearance and mass. Using FIP, a spiral galaxy can be compared to an atom.

FIGS. 19 and 19a show how KFE gives rise to features which can be targeted. Since all features of all dimensional elements are built from fpix (and its components), it is important to see how the two spiral models originate.

FIG. 19 shows the plot of points from the fractal modeling of fpix and 1/fpix. Dimensional features arise from fpix and this can be seen as originating from this Figure. Closeup 758 shows an isolated view of item 715 and surrounding features for clarity.

FIG. 19a shows a close-up near the intersection 759 for clarity.

The curves, best seen in FIGS. 19 and 19a, include one divided by the sum of fpix called positive and negative reciprocal curves, PR-curve 734 and NR-curve 735 (because they reflect the mathematical graphing result of x/sum(fpix) with additional resonance at curves referred to by their formulation as x/sum(fpix) and reflecting the intersection resonance 730 where the line defined by fpix, fpix plot line 732 intersects with PR curve 734 or NR curve 735. The diameter 715 of circle 715a reflects the distance from resonance 730 to intersection 759 where items inverse fpixline 733 and fpixline 732 intersect with each other and the x axis 748 along fpixline 732. Using the diameter 715 as a base, the length of item 715 times 2, giving the resulting circular area a value of the circle 715a raided to the power of 2, can be used to measure additional points of reference. It can be seen that the various curves are defined not by the x axis 748 and y axis 749, but instead between the x-axis 748 and offset y axis 750.

To allow for a common language for different parts exponential designations which are multiples of diameters and resulting curves are designated with parenthetical of the doubling diameter. For this reason, PRcurve 734 is a plot of a portion of 1/fpix, the portion of this plot of 2/fpix is designated as PRcuve2 734(2), 4/fpix is PR-curve4 734(4), and for 16/(fpix) PR-curve16 734(16), and there is an indicator 747 showing how far out 734(32) would be at its closest point to 16/sum(fpix) 734(16) were it to be shown. Curve 2/sum(fpix) 734(2) is also shown just so that a non-resonant curve can be seen.

This designation is used for NRcurve 735 and a second set of curves with the same resonance, but based on inverse relationships about the same intersection 759 but using the intersections with inverse fpix plot line 733 seen as BPR curve 754 and BNR curve 755. Since resonance is the same for the curves other than the positive (relative to the x axis 748 for the positive and negative designation) these have the same numbering format, for example, NRcurve 735 gives rise to NRcurve2 735(2).

Items 734 and 735 are distinguished from items 754 and 755 as items 754 and 755 reflect the opposite modeling and a referred to as B-curves to distinguish them, one set being based on real numbers and the other on the non-real numbers.

The resulting structure shown in FIGS. 19 and 19a show how dimensions are built from fpix. They can be used for controlling the transitions of matter in either direction and the example shown in FIG. 1 is for Fission and FIGS. 14 and 14a for fusion.

The 0.5 offsets 731 between the y axis 749 and the offset y axis 750, also from x-y axis intersection 738 to intersection 759 can be used as the diameter for a base circle which is mathematically the same as item 67 in FIG. 8 which is also shown in FIG. 15 where it is a fractal equivalent as the overlap 67e (e standing for fractally expanded) of the MI spirals used for fusion. For example, it is the same as the diameter of the radiation source in FIG. 1a and is a representation of the base of all 2\hat{ }n (the area of the circle defined by diameter equal to intersection 759 has 2\hat{ }n information where n quantum changes (1,2,3, etc.) are equal to 2\hat{ }n. Items 731 and 715 provide two different points of resonance. For example, item 731(4) shows the closest point of curves 734 and 735 to one another, while item 715 shows the distance between intersection 759 to curves 734 or 735.

These two points of resonance show up in various guises and can both be taken into account in modeling. For example, the length of item 625, 625\hat{ }n shows up at a scale of 64 (4\hat{ }3 using 0.625 as base 1 or 0.625\hat{ }4) enclosing the outer MI legs with overlapping spirals which is also the extreme point of the galaxy's width.

Not that this resonance shifts, presumably with charge so that x/fpix for x=4 and 16 align with fpix graphed against the real number versions for x/fpix and for x=12 (electrons?) it aligns with the line for 1+fpix which is parallel to the line for fpix but passing through the center instead of −0.5. This modeling It shows the origin of 2, 2\hat{ }n (exponential features continue in 4\hat{ }n resonance when dealing with fpix separated into its components) and 4 as the resonance of 4\hat{ }n which allows application designs in any scientific area and why 4/fpix has precedence since 4/fpix resonance means that 4 and fpix in the numerator are interchangeable in terms of mathematical stability.

While we cannot see this type of separation (−1 and 1) at pre-time levels, we can see the transition between fpix and MI based on the separation of the positive and negative features. We also see the dimensional overlap of MI (1:2:1) as the separation of golden ratio spirals (FIG. 16) and fpix (FIG. 19c). Showing 4 sets of curves based on 1/fpix modeling.

Using fractal modeling, this can be seen as a hybrid structure in order to allow the potentials to be recognized to reduce heat and other energy types to current and otherwise disperse them as explained in FIG. 1

The claim is a method of manipulation tied to targeting dimensional changes inherent in the observed geometry and transitions of geometry in the universe which allows a patent claim based on issues of geometry and resonance for any type of information in the universe.

In prior methods, it was necessary to have a plethora of different categories, physics, chemistry, engineering, and the like. Under the method proposed here, you can eliminate all of those since every feature (from space itself, through energy, matter, and black holes) is united by a single process of dealing with them via transitions in geometry based on fractal mathematics and information physics.

While much of the discussion centers on fission and fusion, the beauty of the process is that it can be applied to all dimensional features of a universe which is dimensional at all levels where we operate. Solar absorption follows the same patterns as radioactive absorption.

Dimensional shapes and transitions to and from those shapes can be used to design any transition and therefore any process more efficiently according to the fractal, information physics method taught. Working along the paths desired and creating those paths by shape and transitional process allows for these efficiencies.

### Shape and Transition Origins

Using simple Pythagorean mathematics, the resonance, beginning with resonance 730 defined by the diameter of circle 730a in FIG. 19 can be determined from the resulting shapes, the degree of resonance (the more quantum (even numbered) the transition, the stronger the resonance. Hence where the numerator is 4, there is a resonance of 2.5, 5 at 8, and 10 at 16 looking at the last 2 columns based on the length (originating at 0.625) of the line along plotfpix 732 or 733 to a corresponding curve shown by items 734, 735, 754 and 755. This can be viewed as the origin of exponential compression (2\hat{ }n). Since the curve items come in pairs offset by 0.5 shown as offset 731 from the intersection of the x axis 748 and y axis 749, that can be viewed as the origin of 2(f(n).

| | | | | | | | | | | | |
|---|---|---|---|---|---|---|---|---|---|---|---|
| | | | | 68 | 16 | | | | | 10 | 16 |
| | | | | 42.5 | 10 | | | | | 6.25 | 10 |
| | | | | 38.25 | 9 | | | | | 5.625 | 9 |
| | | | | 34 | 8 | | | | | 5 | 8 |
| | | | | 29.75 | 7 | | | | | 4.375 | 7 |
| | | | | 25.5 | 6 | | | | | 3.75 | 6 |
| | | | | 21.25 | 5 | | | | | 3.125 | 5 |
| | | | | 17 | 4 | | | | | 2.5 | 4 |
| 1.5 | 2.5 | | | 12.75 | 3 | 0.5 | 1 | | | 1.875 | 3 |
| 2.25 | 6.25 | 8.5 | 4.25 | 8.5 | 2 | 0.25 | 1 | 1.25 | 0.625 | 1.25 | 2 |
| | | | 2.125 | | | x\hat{ }2 | y\hat{ }2 | sum | sqr root | | |
| | | | | | | | | y ratio | 0.8 | 1.25 | |
| | | | | | | | | x ratio | 0.4 | 2.5 | |

Dimensional features begin with the elements of fpix, but for these purposes, we can start with fpix. FIG. 16 shows an alternative view of the shifting dimension between fpix and MI where the fulcrum changes from one defined by curve items 735 and 736 to overlapping spiral items 339 and 340. The resulting linear fpix results intersect with the curved reciprocal of fpix at fixed intervals showing how curvature originates from information compression and resonance from harmonics inherent in the relationships of compression of information and its reciprocals.

### Harmonic Theory:

Stability lies in the harmonics associated with fpix, namely where fpix intersects with 1/fpix. As can be above this analysis can vary a little depending on the units used to begin. For clarity, the offset (along the x axis) is shown as 0.25 and the resulting point of resonance where fpix intersects with 1/fpix is at 0.625 which is also half of the sum, so they square and the resulting ratios are harmonic. Likewise, two times the resulting base diameter x1 is 1.25, the same as the ratio of the yratio to the length of the y axis, the offset determined using basic Pythagorean mathematics. One can then look at the initial offset's relationship to the resulting harmonics. Quantum (1,2,3, etc.) counts show some level of harmonics, but unitary harmonics occur at 4 and then 4\hat{ }n as the positive values (4,16) of 2\hat{ }n giving rise to the prominence of 4/sum(fpix) and observed forces can be seen as resulting from the harmonics at 2\hat{ }n and 2x as there are two offset curves ignoring unreal number results. If all results are included there are 2 sets of two offset curves.

One can think of the two versions of offset spirals as those with both positive and negative components resulting from real numbers −1\hat{ }even; vs. those offset curves which have either positive or negative components (−1\hat{ }odd). This is comparable to the positive fpix values giving rise to the noble gases and the odd values giving rise to the semiconductors in the PTE.

This shows the origin of 2f(x) and 2\hat{ }n compression which can be separately targeted as shown in FIG. 14 and FIG. 15.

A circle is based on the resonance of 4 divided by fpix summed because of this resonance and these opposite-formed curves convert into the measurements of the resulting circle, Harmonics based on nfpix/fpix occur at one (unity) and diameters (based on the center of fpix and the x axis) at four and 4\hat{ }n. This evolution of dimension (circles/pi) allows for the targeting of dimensional changes based on these evolving features evolving or devolving can be targeted along any of the critical elements, 2f(n)\hat{ }n−1, −1\hat{ }x, the resonance and the combination of these features and their reciprocals.

To get the 2 sets of offset curves as shown in FIG. 19, it is possible to graph real and unreal number solutions to fpix which resulted in 4 sets of identical curves about an axis and resonance at 4. Otherwise, there is one set of offset circles as shown in FIG. 19a which zooms in to allow a better view of the internal features. This shows curves formed from plot 734, plot 735, plot 752, and plot 753 with resonance reflecting the intersection of these plots with plotfpix 732 and inverse plotfpix 733. The designations of x axis offsets as being positive could be replaced with negative 0.5 along the x axis instead of 0.5 depending on how the graphing is undertaken, although the resonance relationships would be the same.

This is not just a math concept because it reflects how “durable” dimension and spherical relationships start from quantum information (fpix solutions) as a result of resonance.

Inherent in these is the divisibility of the radius or diameter, 2f(n) works with ½ f(n) for resonance. The shift to 0.5 reflects the offset necessary to create “dimension” from a linear set of points.

This shows the creation of potential since the expansion and collapse of the spirals into folds shown in the accordion-like folding of fpix exemplified in FIG. 17.

The nature of folding as being incomplete ensures separations at the quantum level reflected at higher levels of compression. The universe does not collapse because fractals resulting from the underlying universe do not collapse all the way as they fold.

When one thinks of the inverse fpix positive y 734 and negative y 735 of FIG. 19 coming together about an offset 0, −5 731 one can envision fusion through shifting compression from two offset directions.

If one wants to make efficient fusion, compression according to fpix (as opposed to the steps of MI) occurs reflecting how fpix gives rise to a circle, not just by defining the opposing curved surfaces, but the counterpart of a point between the two curves 734 and 735 which expand evenly from successively smaller curves about the offset intersection 759.

FIG. 20 is a Chart showing Resonance and the rule of 4(s) which can be used to target electromagnetic, chemistry, fission, and fusion modeling. In base 10, fpix intersects at multiples of four for the numerator as 4\hat{ }n/fpix (1/fpix,4,16,64,251), item 730 in FIG. 1. Because any multiple of 4 is your numerator, this regular pattern corresponds to intervals or oscillations in the curved function. An equation is linear, and the reciprocal of the equation is curved. At fixed values of the numerator x, x\hat{ }2, x\hat{ }3 the result is an integer. Otherwise, fpix is largely an irregular fraction.

Since observed curvature is based on 4 (and 4\hat{ }x is the series of resonance points for fpix and its inverse) and since the radius of a circle yields 2\hat{ }n as it doubles, the observed feature of 2\hat{ }n is seen to be mathematically resonant and tied to doubling circles because pi is defined at a point of resonance (it almost had to be since the universal appearance of curvature is necessary evidence of the applicability of fpix as a quantum bit) and resulting circles reflect 2\hat{ }n compression.

Another resonance is shown, as at 0.04, 0.16, at 1 and 0.01, 2.56 (compare 256), 100, and 400; all relevant, in base 10 the consistent symmetry is 4\hat{ }x observed at dimensional scales we are most familiar with pi (4) based on 4 as the numerator over the sum of fpix being pi.

This informs the nature of fpix. Changing the numerator to a negative number does not show the symmetry since while the curves remain the same for the inverse of fpix, they are rotated 90 degrees to the point −0.5, 0 so they no longer intercept at the fpix line through −0.5 and instead the lines of the two curves converge on either side of the fpix line along both the x and y axis center at −0.5, 0.

The line representing the sum of the fpix value, as opposed to those values alone, moves left as the number goes up so at −100 to 100 it is at approximately −100.50001, 00002); at 0 to 100, it is at approximately 50.50002 to 0 (0.00004). This is just a chart of various representations of resonance, fpix, x/fpix (where resonance with fpix can be seen); sum (a to b) of x/fpix, for example, which can be graphed to observe resonance.

The intersections at powers of x=4 highlight underlying symmetries, where certain multipliers align more perfectly between the linear transformations and their reciprocals.

These points of intersection can be viewed as resonances-harmonic mathematical inflection points which can be viewed from the perspective of time to include frequencies where the transformations synchronize up, yielding integer values (note that because of the −0.5 offset, the ×0.5 values are integers which start at −0.5).

Resonance, at its core, is about synchronization and amplification. In many systems, it occurs when the natural frequency of the system matches the frequency of an external force, leading to a significant increase in amplitude.

FIG. 15 shows how we can count out patterns to find the 1,2,3,5,8 and 1,3,5,7,9 patterns in the graphed drawings pretime change subsuming at different levels or in areas each possible.

The spiral area building looks like this:

| | |
|---|---|
| 1 bottom spiral (683) | 1. Top spiral 683t |

Size a separation based on the size of the overlap of the spirals

| | |
|---|---|
| 2 2 × 1 above 683a | 2. Below b83at |
| 3 3 × 1 to the right of 2 683b | 3. To the left of 2 683bt |
| 4. 5 × 1 below 683c | 4. Above 683ct |
| 5. 8 × 1 left | 5. Right |
| 6. 13 × 1 above | 6. Below |
| 7. 21 × 1 right | 7. Left |
| 8. 34 × 1 below | 8. Above |
| 9. 55 × 1 left | 9. Right |

Seeing the placement of the first items 683, 683t, 683a, 683at, 683b, 683bt, 683c, and 683ct in FIG. 15, the rest can be assembled based on this modeling.

The offset becomes the MI offset in MI compression with one arm being off one side and the other off the other. This leads to a different offset in offset (resonance 730, as opposed to the 0.5 offset 731) for item 666 and item 667 in FIG. 14 based on the Pythagorean (2\hat{ }+3\hat{ }2)\hat{ }½ offset from one another by ⅔.

FIG. 15 and FIG. 16 show the combination of fpix, golden ratio, and MI modeling for the atom.

The foundation modeling of the geometry of energy creates exponential math modeling and fpix modeling, fpix has exponential features so these should not be surprising. fpix=−1\hat{ }x+[2x*−1\hat{ }(x−1)], but these manifest halves of exponential math. This halving is more like mixing the two halves with each other.

A look at how fpix is calculated over the first 5 numbers. Pi is the sum(x=1ton)4/fpix(x)dx. Traditionally this is viewed as summed from zero to infinity, but the degree of compression determines how many steps are incorporated into the calculation (2.66 . . . ,3.466 . . . ,2.895 . . . , and by n=500 it begins to vibrate around numbers we look at for pi (3.1435 and 3.1397 for example). It arrives essentially at curvature as we envision it (at infinity) at the proton where n is in the range of 10\hat{ }30. While for most calculations this can Heat and electric manifestations can be targeted at the resulting harmonics and the relationship of two portions of the fpix solutions at the photon level as orbitals.

This can be used in direct transitions to electricity from other forces by creating a potential out of extremely targeted energy, there is a “space” where the high end and low end of this energy exist and then break it into smaller potentials till you get to the one that can be used as electricity. The key is to create the right potential at different locations and then tap it using fractal modeling.

Fpix gives rise to the denominator of pi and the mathematical resonance of this equation gives rise to the numerator of pi. Since curvature is ubiquitous, this equation is present in proximity to all dimensional aspects of the universe from space to black holes. The premise, borne in observations, is that all dimensional features, space, force, energy, and matter, can be defined using permutations of this ubiquitous fractal feature.

2*2\hat{ }n (4\hat{ }n) is one way to express resonance at 4

FIG. 10 gives a different view of the compression in conjunction with FIG. 15 and FIG. 16 for fpix to MI transition is that the 1, −3 components of transition suggest it takes 3 negatives and 1 positive spiral form to make the overlapping area of proton to neutron fusion or the equivalent separation radius of neutron bonding.

In this case, it can be seen that spirals 734 and 735 ultimately have to collapse to form the overlapping f-series spirals with the interim result being an average reflected as the top golden ratio spiral 739 and the bottom golden ratio spiral 740

This shows numerically that adding fpix solution, separated into positive and negative results, allows adding the solution in the prior column to the negative in the next column, and carrying this process forward provides the necessary conversion from fpix to MI solution. It represents the transition and “sort of” focuses on the addition of positive real numbers (after 2).

In order to get the desired combinations FIG. 10 shows positive and/or negative fpix solutions combining to give MI solutions at 2 with combination 633, this process goes from 2 to 3 with combination 634. Note that negative values (−1) proximate to 2 can give rise to values of 1 to combine with 2 also. The process continues with combinations 635 to give 8 and so the process of transition between the two can continue. A more balanced approach 636 is possible since balance is required, but what this reflects is the compression of information to go from offset curves to overlapping spirals. This goes from a loose to a more rigid architecture.

The present invention offers several notable advantages by achieving a unified approach to modeling, designing, and understanding various systems and processes through a single underlying mathematical framework. By substituting different technologies and languages with fpix solutions (ct1 states), the invention streamlines and enhances the efficiency of scientific modeling. This innovation allows for translating any desired outcome into the FIP model, enabling the most efficient execution of processes. Furthermore, it provides a method for converting prior art modeling into FIP modeling, fostering a deeper and more efficient understanding of features from a novel perspective. The invention also significantly enhances the application of fractals in data science, modifying AI software to maximize the accessibility, organization, and value of empirical data. This approach allows for the use of fractal modeling to design chemical and biological functions, improving the accuracy and efficiency of AI predictions. The fractal model is versatile, and applicable across various systems such as energy, atomic, chemical, and biological systems, and it enables the categorization of data from sub-atomic to astronomical features within a unified framework.

Additionally, the invention develops a classification system that cross-characterizes existing empirical non-fractal data across multiple scientific domains, aligning them with the fractal modeling framework. Integrating this fractal model into AI software enhances the software's capability to access, organize, and analyze empirical data more effectively, thereby improving the prediction of chemical and biological functions. In the context of atomic interactions and energy transfer, the invention utilizes fractal analysis to identify patterns in empirical data, developing fractal atomic structure definitions and mathematical models that optimize transitions between energy and matter. This leads to increased efficiency in energy processes. The system for automated fractal analysis of empirical chemistry data is another advantage, comprising a database, software module, and processor that facilitate the extraction, categorization, and simulation of data based on fractal constraints. This system optimizes reactions and energy processes by utilizing Key Fractal Elements (KFE) to influence CT states and interpret matrices of these states. Moreover, the invention provides a method for controlling the compression and decompression of CT states within and between multiple AuT matrices, governing changes through KFE to achieve desired dimensional variations. This control extends to the creation of new materials and substances and enables the modeling and simulation of complex systems and phenomena, offering a powerful method for predicting the behavior of dimensional systems.

While the foregoing describes various embodiments of the disclosure, other and further embodiments of the disclosure may be devised without departing from the basic scope thereof. The scope of the disclosure is determined by the claims that follow. The disclosure is not limited to the described embodiments, versions, or examples, which are included to enable a person having ordinary skill in the art to make and use the disclosure when combined with information and knowledge available to the person having ordinary skill in the art.

What is claimed is:

1. A method for manipulating matter and energy using Key Fractal Elements (KFE), the method comprising: identifying a target system with dimensional features defined by fractal-based models, the dimensional features including at least one of: solutions to fpix equations for curvature-based compression states; MI-based Fibonacci sequences for dimensional transitions; transitions between the fpix and MI, wherein the transitions occur in either direction, reflecting the gradual change from the fpix to MI, and vice versa, further wherein a golden ratio is a combination of both the fpix and MI elements, showing the interconnected nature in creating fractal structures; reciprocals of one or more elements from the fpix and MI; resonance resulting from interaction of the one or more elements giving rise to compression about a fulcrum represented by the equation (2f(x)\hat{ }2(x)) describing exponential growth and compression, wherein f(x) corresponds to at least one of: the fpix and the MI depending on state being modeled; applying fractal modelling to determine optimal transitions between compression and decompression states within the target system; adjusting input parameters to the target system based on predicted fractal patterns related to the KFE; monitoring real-time changes in the target system using fractal constraints; and iteratively refining process to optimize desired physical, chemical, and energetic outcome.

2. The method of claim 1 wherein the fractal modelling incorporates at least one of:
a resonance based on 4ⁿ iterations, compression states based on 2ⁿ; 2f(n) where f(n) corresponds to at least one of: the fpix, CGP, MI, and a transition state, dimensional transitions, and a transition equation including at least one KFE involving 2f(n)\hat{ }(2\hat{ }n), where f(n) is selected from at least one of: the fpix, MI, and a transition state between the fpix and the MI.

3. The method of claim 1 further comprising at least one of: designing matrices for atomic and molecular structures based on KFE by: identifying and categorizing dimensional features using fractal patterns; and modelling at least one of: compression and decompression states to optimize molecular and atomic interactions.

4. The method of claim 1, wherein the target system is a radioactive material, and the method includes: using the fractal modelling to design semiconductors for converting radiation into electricity; and incorporating materials including at least one of: lead (Pb), tin (Sn), and corresponding hybrids for energy transfer.

5. The method of claim 1, further comprising optimizing nuclear fusion processes by: designing radiation matrices for fusion energy production; and using KFE to stabilize fusion reactions and enhance energy release.

6. The method of claim 1, further comprising optimizing nuclear fission processes in reactors by: designing fission reactors with fractal-layered structures for energy conversion; and controlling fission reactions using KFE to maximize energy output and safety.

7. The method of claim 6, wherein the fission chip includes: layers incorporating fractal models for efficient energy transfer; and systems for converting radiation into usable energy through fractal-guided pretime changes.

8. The method of claim 1, wherein the fractal modelling is integrated into artificial intelligence software to: convert empirical scientific data into fractal-based representations; predict chemical and biological functions using fractal algorithms; and enhance the accuracy and efficiency of AI systems in analysing scientific data.

9. The method of claim 8, further comprising using the AI software to: generate fractal models predicting transitions between energy and matter; and refine fractal predictions based on discrepancies with empirical data.

10. The method of claim 8, wherein the AI system is further configured to: generate automated fractal classifications for unstructured scientific data; and identify non-fractal anomalies within datasets to improve prediction accuracy.

11. The method of claim 1, further comprising using the fractal modelling to optimize chemical reactions by: predicting reaction kinetics using fractal overlaps of molecular states; and designing reaction pathways to enhance selectivity and product yield.

12. The method of claim 1, wherein the fractal modelling is applied to biological systems to:
predict biological behaviours using fractal patterns; and optimize the design of biological processes based on fractal transitions.

13. The method of claim 1, wherein the fractal modelling is used to design radiation matrices for energy storage systems and the method comprises: configuring layers to optimize pretime energy capture and release using fractal principles; and incorporating fractal resonance to stabilize energy storage and transfer.

14. The method of claim 1, further comprising designing layered semiconductor arrays for dual-purpose fission and fusion systems, wherein the arrays: leverage overlapping MI spirals for neutron compression; and optimize energy transfer and reduce waste heat using fractal transitions.

15. A system for automated fractal analysis of empirical data, the system comprising:
a database for storing empirical data related to atomic, chemical, or biological systems;
a software module configured to: extract features from the data and categorize them using fractal constraints; generate fractal models predicting transitions between energy and matter; and perform simulations to validate the fractal models against empirical data.

16. The system of claim 15, further comprising: a processor configured to iteratively refine the fractal models based on discrepancies between simulation results and empirical data.

17. A method for analysing dimensional features using fractal-based modelling, the method comprising:
identifying dimensional features within a target system based on solutions to fpix equations; categorizing the features into compression and decompression states using fractal overlaps; designing transitions between features to optimize the behaviour of the target system; using fractal resonance to improve system efficiencies in at least one application selected from: electromechanical systems, chemical reactions, energy storage or generation, and quantum computing.

18. The method of claim 17, further comprising using fractal modelling to enhance energy conversion by: configuring transitions between fpix-defined geometries and MI-defined geometries at neutron bonding; and optimizing electromagnetic interactions for improved energy transfer.

19. The method of claim 17, further comprising using fractal modelling to design molecules with tailored properties for energy systems.

20. The method of claim 17, wherein the application is quantum computing, and the fractal modelling is used to: optimize the stability of quantum states; and enhance computational efficiencies using fractal-defined transitions.
